(19) United States
(12) Patent Application Publication
(10) Pub. No.: US 2006/0147635 A1
(43) Pub. Date: Jul. 6, 2006

(54) Coating apparatus and producing method for die coater

(75) Inventor: Shigetoshi Kawabe, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/318,902

(22) Filed: Dec. 27, 2005

(30) Foreign Application Priority Data
Jan. 6, 2005 (JP) JP2005-001258

(51) Int. Cl. B05D 3/00; B05D 3/02; B05C 5/00

(52) U.S. Cl. 427/299; 118/302; 118/300; 427/314; 427/331; 427/372.2; 427/375; 427/385.5

(57) ABSTRACT

A coating apparatus having a die coater incorporating at least two bars, the die coater composed of a pocket section for extending a coating solution in a coating width direction, a coating solution supply port for supplying the coating solution to the pocket section, and a slit section for discharging the coating solution from the pocket section to an object to be coated, wherein at least a portion of the bar which forms a surface of the die coater and comes in contact with the coating solution is applied with coating of a fluorine based resin, and baking of the fluorine based resin is carried out in a backing furnace while the bar is suspended with one end face of the bar up, and then finish grinding is conducted for the bar.

This application is based on Japanese Patent Application No. 2005-001258 filed on Jan. 6, 2005 in Japanese Patent Office, the entire content of which is hereby incorporated by reference.

### BACKGROUND OF THE INVENTION

The present invention relates to a coating apparatus provided with a die coater having at least 2 bars mounted thereon and to a method of manufacturing the die coater, and specifically, related to the coating apparatus and the manufacturing method wherein the coating apparatus provides a stable coating layer thickness along the coating width direction, causes few coating failures and achieves an excellent coating quality as well as an excellent cleaning facility.

In the prior art, as a method for coating on a continuously running belt-shaped support material or a base board (hereinafter, also referred to as “support material”) with a coating solution (including, for example, coating solutions for undercoating, over coating and back coating) for surface treatment of materials such as photographic photosensitive materials, heat development recording materials, abrasion recording materials, magnetic recording media, glass plates, steel plates, etc., there are known methods such as a dip coating method, a blade coating method, an air knife coating method, a wire bar coating method, a gravure coating method, a reverse coating method, a reverse roll coating method, an extrusion coating method, a slide coating method, and a curtain coating method.

Among these, a slide coating method, an extrusion coating method, and a curtain coating method allow high speed coating, thin layer coating, and simultaneous multi-layer coating, and accordingly, are widely used in coating photographic photosensitive materials, heat development recording materials, and abrasion recording materials. As coating apparatuses to be used in these coating methods, slide type die coaters for a slide coating method, extrusion type die coaters for an extrusion coating method, and curtain type die coaters for a curtain coating method are used.

As structures of the die coaters, in the case of a slide type die coater, for example, the die coater has a slit section allowing a coating solution flow out, a liquid storing section called as a pocket section for supplying the coating solution uniformly in the width direction of the slit section and a slide section on which the coating solution having flowed out of the slit section flows, the sections of which are constituted by at least two bars. The slit section, the pocket section, the slide section, a lip section, and an outer wall that is continuous with the lip section are portions that come in contact with the coating solution.

As for performing coating of a coating solution of a photographic photosensitive material containing silver halide grains or of a heat development recording material by the use of a slide type die coater, an extrusion type die coater, or a curtain type die coater, it is known that a portion, of these various die coaters, which comes in contact with the coating solution has the following problems.

Regarding an outer wall continuous with the lip section, when a flow rate is set at the start of coating and when coating is terminated, a coating solution flows down along the outer wall continuous with the lip section, adheres to the outer wall, and then gets dry and solidifies, resulting in painstaking cleaning after the termination of coating.

Tiny foreign materials and silver halide grains may adhere to the slit section, the pocket section, the slide section, and the lip section. In the course of coating for a long time, tiny foreign materials and silver halide grains adhering to these sections turn into a core, then further foreign materials and silver halide grains adhere to the core, and thus an adhering deposit may grow. If the deposit grows to a certain extent in this way, the flow rate and speed of a coating solution vary at the deposit, which makes the flow of the coating solution unstable, resulting in a coating failure and difficulty in commercialization. It is understood that these foreign materials and silver halide grains appear, for example, in such a way that foreign materials adhering to dead spaces of joint sections and valves of pipes which are disposed in a complex coating solution supply system extending from a coating solution supply pipe to the exit of a slit section of a die coater are torn off by the flow of the coating solution, and silver halide deposits to become grains in the coating solution in the course of coating of the coating solution for a long time.

Particularly, at a start of coating, a coating solution flows rapidly in a coating solution supply system, which tears off tiny foreign materials adhering to the respective dead spaces of the coating solution supply system, and then the foreign materials adhere to portions of the die coater where the die coater is in contact with the coating solution. Moreover, a coating solution adheres also to the outer wall which leads to a lip section, and dries and becomes a solid. For coating for a long time, the following solutions are known which prevent silver halide grains depositing in a coating solution and tiny foreign materials from easily adhering to the portions, of a die coater, which is in contact with the coating solution, and allow stable coating and easy cleaning after the termination of coating.

For example, there is known a technology in which a pocket section, a slit section and the like of an extrusion type die coater are formed with a fluorine based resin so that cleaning and disassembling are easy (referring to Patent Documents 1 and 2, for example). Another technology is known in which the periphery of a slit section of an extrusion type die coater is lyophilized with a fluorine based resin to allow forming of a thin layer without a streak type unevenness (referring to Patent Document 3, for example). Still another technology is known in which the outer wall side surface of an extrusion type coater for coating base materials is covered with a fluorine based resin to prevent retention of a coating solution at a start of coating and to achieve an uniform layer thickness (referring to Patent Document 4, for example).

The technologies disclosed in the above stated Patent Documents 1 to 4 are so excellent as to allow it to prevent adherence of foreign materials by covering the portions of a die coater in contact with a coating solution with a fluorine based resin, but these technologies have the following problems.

As a coating layer thickness is required to be accurate, the straightness of a die coater is also required to have an accuracy of a few micrometers. When carrying out a coating process to cover the fluorine based resin on a bar, and in the case that coating width is less than about 1 m, an influence of the baking treatment at the time of the coating process hardly causes a problem. However, in the case of a bar used for a die coater having a coating width exceeding 1 m, the influence of baking heat treatment in a fluorine based resin coating process is so significant that although a die coater produced having bars covered with the fluorine based resin can prevent coating failures due to adhesion of a coating solution, but the die coater is not allowed to attain uniformity of layer thickness in the width direction of the coating, thus only can conduct coating of a quality that does not require uniformity of the coating layer thickness. For this reason, in order to suppress generating of coating defects, without carrying out a coating process of the fluorine based resin, a coating was not performed for a long time, and cleaning was conducted frequently, resulting in that the working efficiency of the manufacturing process is lowered.

Therefore, there have been a demand for a coating apparatus using a die coater with a width of 1 meter or longer and a method of producing the die coater, wherein the die coater has been covered with a fluorine based resin for easy cleaning on the portions that come in contact with a coating solution and achieves products that are coated with a uniform coating thickness in the width direction of coating and have few coating failures even after a long coating operation.

After dedicated studies and researches, the present inventors found that the die coater of a coating width of 1 meter which was equipped with at least two bars coated with fluorine based resin was apt to deteriorate uniform coating layer thickness distribution in the coating width direction when it was used for a long time by the following reasons.

As the time passes, the internal stresses of bars which constitute the die coater and stresses left on the bars when the bars were baked emerge and deteriorate the straightness of parts such as pocket, coating solution supply port, slit, edge, and lip sections, which are in contact with the coating solution of the die coater. The deterioration of the straightness makes the slit opening uneven along the coating width and makes the distance between the die coater and the support material non-uniform. This deteriorates the evenness of the layer thickness in the coating width direction.

The present inventors dedicated themselves to studying and researching what deteriorated the straightness of bars which constituted the die coater when the die coater was used for a long time. As the result the inventors drew a conclusion that the straightness of bars which constituted the die coater was much deteriorated if the precision of the top of a baking table on which the resin coated bars were placed, after coating of fluorine based resin, for baking was low because the bars were affected by disturbances such as expansion, shrinkage, bending, and deformation of the top of the baking table. When such baked bars were ground to correct the straightness, they had to be ground too much and have a lot of grinding stress left on them. Naturally, when the die coater having such stressed bars is used long, the stresses left on the bars will emerge, distort the entire die coater, and consequently, deteriorates the evenness of layer thickness in the coating width direction.

After studies and researches considering the above, the present inventors found that the inventors can minimize the distortion of straightness of bars in the baking process, the quantity of grinding in the finish grinding process and residual machining stresses of the bars effectively by isolating the bars from disturbances by the top of the baking table on which the resin coated die coater bars are placed for baking. This has led the inventors to this invention.
[Patent Document 1] TOKKAI No. H11-156265
[Patent Document 2] TOKKAI No. 2001-269606
[Patent Document 3] TOKKAI No. 2001-191004
[Patent Document 4] TOKKAI No. 2001-276709

### SUMMARY OF THE INVENTION

With the background stated above, an object of the invention is to provide a coating apparatus using a die coater with a width of 1 meter or longer and a method of producing the die coater, wherein the die coater has been covered with a fluorine based resin for easy cleaning on the portions that come in contact with a coating solution and achieves products that are coated with a uniform coating thickness in the width direction of coating and have few coating failures even after a long coating operation.

One embodiment to achieve the above object is a coating apparatus having a die coater incorporating at least two bars, the die coater composed of a pocket section for extending a coating solution in a coating width direction, a coating solution supply port for supplying the coating solution to the pocket section, and a slit section for discharging the coating solution from the pocket section to an object to be coated, wherein at least a portion of the bar which forms a surface of the die coater and comes in contact with the coating solution is applied with coating of a fluorine based resin, and baking of the fluorine based resin is carried out in a baking furnace while the bar is suspended with one end face of the bar up, and then finish grinding is conducted for the bar.

Further, another embodiment is a method of producing a die coater structured of at least two bars having a pocket section to extend a coating solution in a coating width direction, a coating solution supply port to supply a coating solution to the pocket section, and a slit section to discharge a coating solution from the pocket section to an object to be coated, wherein at least a portion of a surface of the die coater coming in contact with the coating solution is coated with a fluorine based resin.

The method is composed of a coating process of coating at least a portion of a surface of the die coater coming in contact with the coating solution with the fluorine based resin, a baking process of the fluorine based resin conducted in a baking furnace while the bar is suspended with one end face of the bar up and a finish grinding process conducted after the baking process and a mounting process of the bar to produce the die coater.

### BRIEF DESCRIPTION OF THE DRAWINGS

FIG. 1 is a schematic diagram of a slide coating method which uses a slide type die coater to form beads and coat.

FIG. 2 is a schematic diagram of an extrusion coating method which uses an extrusion type die coater to form beads and coat.

FIG. 3 is a schematic diagram of an extrusion coating method which uses an extrusion type die coater of FIG. 2 to coat a support material supported by a supporting roller.

FIG. 4 is a schematic diagram of an extrusion coating method which uses another extrusion type die coater to collide coating solutions to a support material across a preset space from slit sections to coat without forming beads.

FIG. 5 is a schematic diagram of a curtain coating method which uses a curtain type die coater.

FIG. 6 is a schematic perspective view of a fluorine based resin coated bar constructing a slide type die coater of FIG. 1 which is hung for baking process in a baking furnace with one end face of the bar faced up.

FIG. 7 is a schematic perspective view of a fluorine based resin coated bar of an extrusion type die coater of FIG. 2 which is hung for baking process in a baking furnace with one end face of the bar faced up.

FIG. 8 is an example of flow diagram of preparing a die coater whose parts to be in contact with a coating solution are coated with fluorine based resin.

### DETAILED DESCRIPTION OF THE PREFERRED EMBODIMENT

The above-described object has been attained with the following configuration.
(1) A coating apparatus having a die coater incorporating at least two bars, the die coater composed of a pocket section for extending a coating solution in a coating width direction, a coating solution supply port for supplying the coating solution to the pocket section, and a slit section for discharging the coating solution from the pocket section to an object to be coated, wherein at least a portion of the bar which forms a surface of the die coater and comes in contact with the coating solution is applied with coating of a fluorine based resin, and baking of the fluorine based resin is carried out in a baking furnace while the bar is suspended with one end face of the bar up, and then finish grinding is conducted for the bar.
(2) The apparatus of claim 1, wherein preheating is conducted for the bar at a temperature equal to or higher than a baking temperature for the fluorine based resin before the coating and grinding is carried out after the preheating.
(3) The apparatus of claim 1 or 2, wherein the grinding includes a first grinding to remove distortion caused by the preheating and a second grinding to finish to final finishing form.
(4) The apparatus of any one of claims 1 to 3, wherein the finish grinding includes a first finish grinding to remove distortion caused by the baking and a second finish grinding to remove thickness unevenness of the fluorine based resin caused by the coating.
(5) The apparatus of any one of claims 1 to 4, wherein a temperature of the baking is 100 to 380° C.
(6) The apparatus of any one of claims 1 to 5, wherein a straightness of a surface of the bar in the coating width direction, on which the coating has been carried out with the fluorine based resin is 0.1 to 10 μm.
(7) The apparatus of any one of claims 1 to 6, wherein the bars have a surface roughness of a portion subjected to the coating within a range of 0.01 μm<Ra<1 μm and 0.1 μm<Rmax<5 μm.
(8) The apparatus of any one of claims 1 to 7, wherein the bars are structure members of the die coater such that a gap of the slit section formed by at least two bars is narrower at an outlet than an inlet of a coating solution and the gap D at the outlet is D≦5×10⁻5 [m], and the die coater jets the coating solution in a layer form in order to make the coating solution collide with the object to be coated with a predetermined gap for coating, the object being disposed or conveyed with no contact with the outlet of the slit section.
(9) The apparatus of any one of claims 1 to 7, wherein the bars are structure members of an extrusion type die coater that extrudes the coating solution from the slit section formed by at least two bars, and forms a bead of the coating solution for coating between a vicinity of a coating solution extruding portion of the slit section and the object to be coated.
(10) The apparatus of any one of claims 1 to 7, wherein the bars are structure members of a slide type die coater that extrudes the coating solution from the slit section formed by at least two bars, allows the coating solution having been extruded to flow down along a slope which is continuous with the outlet of the slit section, then forms a bead of the coating solution between the object to be coated and a vicinity of an end portion of the slope, and coats the coating solution.
(11) The apparatus of any one of claims 1 to 7, wherein the bars are structure members of a curtain type die coater that allows the coating solution having been extruded from the slit section formed by at least two bars to fall freely for coating onto the object to be coated.
(12) The apparatus of any one of claims 1 to 11, wherein the bars are structure members of a die coater having a coating width of 1 meter or larger.
(13) The apparatus of any one of claims 8 to 12, wherein a surface of the object opposite to a coated surface thereof is supported by a back roller.
(14) The apparatus of claim 9, wherein the object is supported by a support roller at a position near the die coater.
(15) The apparatus of any one of claims 1 to 14, wherein the coating solution is a coating solution for a photosensitive layer containing a silver component for a heat-developing photosensitive material or a coating solution for a non-photosensitive protective layer.
(16) A method of producing a die coater structured of at least two bars having a pocket section to extend a coating solution in a coating width direction, a coating solution supply port to supply a coating solution to the pocket section, and a slit section to discharge a coating solution from the pocket section to an object to be coated, wherein at least a portion of a surface of the die coater coming in contact with the coating solution is coated with a fluorine based resin. The method is composed of a coating process of coating at least a portion of a surface of the die coater coming in contact with the coating solution with the fluorine based resin, a baking process of the fluorine based resin conducted in a baking furnace while the bar is suspended with one end face of the bar up, and a finish grinding process conducted after the baking process, and a mounting process of the bar to produce the die coater.
(17) The method of claim 16, wherein a preheating process is conducted and then a grinding process is conducted before the coating process.
(18) The method of claim 17, wherein a preheating process is conducted for the bar at a temperature equal to or higher than a baking temperature for the fluorine based resin.
(19) The method of claim 17 or 18, wherein the grinding process includes a first grinding process to remove distortion caused in the preheating process and a second grinding process to finish to final finishing form.
(20) The method of any one of claims 16 to 19, wherein a temperature of the baking process is 100 to 380° C.
(21) The method of any one of claims 16 to 20, wherein the finish grinding process includes a first finish grinding process to remove distortion caused in the baking process and a second finish grinding process to remove thickness unevenness of the fluorine based resin caused in the coating process.
(22) The method of any one of claims 16 to 21, wherein the finish grinding is conducted such that the straightness of the surface of the bar in the coating width direction on which the coating process has been carried out with the fluorine based resin is 0.1 to 10 μm and a surface roughness of a portion subjected to the coating process is within a range of 0.01 μm<Ra<1 μm and 0.1 μm<Rmax<5 μm.

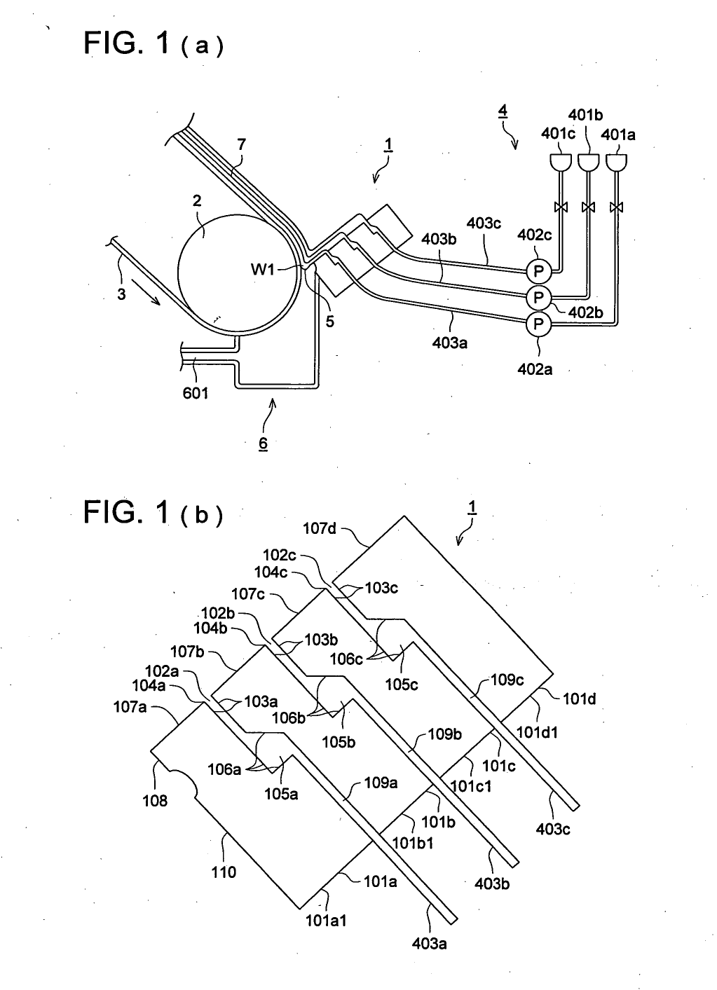

An embodiment of the invention will be described referring to FIGS. 1 to 7, but the invention is not limited to this.

FIGS. 1a and 1b are schematic diagrams showing a slide coating system that performs coating by forming beads by the use of a slide type die coater. FIG. 1a is a schematic diagram of the slide coating system that performs coating on a holding section where a support material is held by a back-roller on a surface opposite to one to be coated, in such a way that the slide type die coater forms beads. FIG. 1b is an enlarged schematic diagram showing the slide type die coater system shown in FIG. 1a.

In FIGS. 1a and 1b, numeral 1 represents the slide type die coater, 2 represents the back-roller, and 3 represents a belt-shaped support material, which is continuously conveyed from the upstream side to the downstream side (in the direction shown by the arrow in the figure). The slide type die coater 1 is produced by mounting respective bars 101a to 101d thereon. The number of bars is not fixed by the bars 101a to 101d, but can be increased or decreased depending on the number of layers to be coated. The back-roller is a conveying roller disposed on the surface of the belt-shaped support material 3 opposite to the coated surface thereof, sandwiching the belt-shaped support material 3 cooperating with the slide type die coater 1. Since the cylindricality of the back-roller has a significant effect on the accuracy of the gap in the width direction of coating as well as the slide type die coater 1, the back-roller is constructed of a metal with a large diameter of 200 mm or larger.

Numerals 102a to 102c represent slit sections serving as an outlet of a coating solution that are arranged between the respective bars 101a to 101d which construct the slide type die coater. The number of slit sections is variable depending on the number of bars such as the respective bars 101a to 101d constructing a slide type die coater, and is ordinarily 2 to 20. The slide type die coater shown in FIGS. 1a and 1b is constructed by mounting 4 bars thereon, thus having 3 slit sections, and used for simultaneous multi-layer coating.

Numerals 103a to 103c represent the inner walls of the respective slit sections 102a to 102c, while numerals 104a to 104c represent edge sections at the outlets of the respective slit sections 102a to 102c. Numerals 105a to 105c represent pocket sections formed at the respective slit sections 102a to 102c so that the coating solutions having been conveyed from respective supplying pipes 403a to 403c, are extruded from the respective slit sections 102a to 102c uniformly in the width direction. Numerals 106a to 106c represent the inner walls of the pocket sections 105a to 105c.

Numerals 107a to 107d represent slide surfaces. Coating solutions adjusted by adjusting pots 401a to 401c of a coating solution supply system 4 are fed to the respective liquid storing sections 105a to 105c formed between the bars 101a to 101d by liquid conveying pumps 402a to 402c through the respective supply pipes 403a to 403c, then the coating solutions are extruded from the respective slit sections 102a to 102c, flow down along the respective slide surfaces 107a to 107c, and form beads 5 through a lip section 108 to be coated on the holding section of the support material 3 that is conveyed in such a way that the surface thereof on the opposite side to the surface to be coated is held by the back-roller 2.

Numeral 110 represents an outer wall that is continuous with the lip section 108. Numerals 109a to 109c represent coating solution supply flow paths for supplying the coating solutions, which have been conveyed from the respective supply pipes 403a to 403c, to the respective pocket sections 105a to 105c.

Numerals 101a1 to 101d1 represent the bottom surfaces of respective bars 101a to 101d opposing respective slide surfaces 107a to 107d and these bottom surfaces 101a1 to 101d1 construct the bottom surface of the slide type die coater 1.

Numeral 6 represents a pressure reducing chamber arranged under the slide type die coater 1 for stabilizing coating and numeral 601 represents a suction pipe. Numeral 7 represents coating layers coated on the support material 3. Symbol W1 represents a coating point where the slide type die coater 1 coats the coating solutions on the support material 3, wherein the coating point W1 is, in a typical case, preferably located at a position downward by 0 to 20 degrees from the horizontal axis that goes through the center of the back-roller.

When coating is performed for a long time, coating solutions adhere to the lip section 108 and the outer wall 110 which is continuous with the lip section 108, become dry and solidify. Further, foreign materials and silver halide grains mixed in the coating solutions adhere to the inner walls 106a to 106c of the respective pocket sections 105a to 105c, on the inner walls 103a to 103c of the respective slit sections 102a to 102c, and on the edge sections 104a to 104c at the outlets of the respective slit sections 102a to 102c. When the deposits are pushed out by the coating solutions and coated on the belt-shaped support material as they are, foreign material adhesion failures occur.

Also, when foreign materials and silver halide grains mixed in the coating solutions adhere to the inner walls 103a to 103c of the respective slit sections 102a to 102c, the edge sections 104a to 104c, the slide surfaces 107a to 107c, and the lip section 108, the flows of the coating solutions at portions with the deposits are not normal and become streaks which cause streak failures.

Further, when a layer created by dried coating solutions adheres to the lip section 108, beads forming becomes unstable, and accordingly, coating becomes unstable. When layers created by dried coating solutions adhere to the outer wall 110 that is continuous with the lip section 108, cleaning after termination of coating becomes painstaking. When adjusting the flow rates of coating solutions prior to a start of coating or when cleaning the inside of the slit sections 102a to 102c, the coating solutions flow down along the outer wall 110, and get dry and solidify. Therefore, the outer wall 110 continuous with the lip section 108 is a portion that needs cleaning such as rubbing off and scraping off such created solids for each coating.

Surfaces of the slide type die coater 1 shown in FIGS. 1a and 1b that contact a coating solution according to the invention include the inner walls 103a to 103c of the slit sections 102a to 102c constructed of the respective bars 101a to 101d, the edge sections 104a to 104c, the inner walls 106a to 106c of the respective pocket sections 105a to 105c, the coating solution supply flow paths 109a to 109c, the slide surfaces 107a to 107c, the lip section 108, and the outer wall 110 continuous with the lip section 108. These portions in contact with the coating solutions are portions to be covered with a fluorine based resin according to the invention.

That is, in the slide type die coater 1 produced mounting the respective bars 101a to 101d thereon, portions, of the respective bars 101a to 101d, coming in contact with a coating solution are the portions to be covered with a fluorine based resin according to the invention.

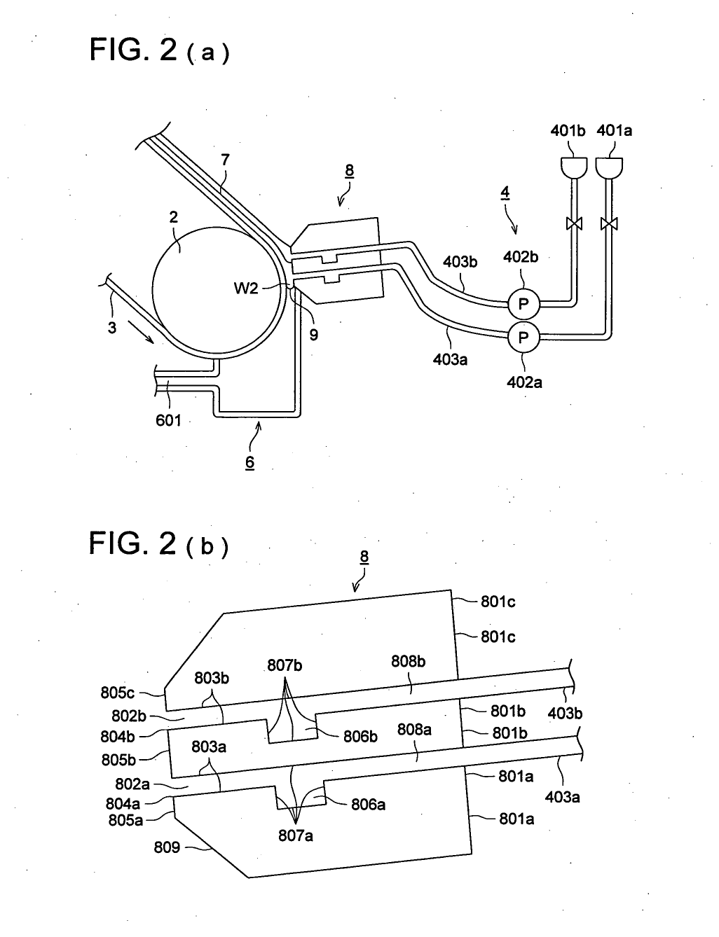

FIGS. 2(a) and 2(b) are schematic diagrams of an extrusion coating system that uses an extrusion type die coater to form beads and perform coating. FIG. 2(a) is a schematic diagram of the extrusion coating system that uses the extrusion type die coater to form beads and perform coating of a holding section of a support material, the support material having a surface, opposite to one to be coated, held by a back-roller. FIG. 2(b) is an enlarged schematic diagram of the extrusion type die coater shown in FIG. 2(a).

Numeral 8 in FIGS. 2(a) and 2(b) represents the extrusion type die coater. The extrusion type die coater 8 is produced mounting respective bars 801a to 801c thereon. The number of bars is not fixed by the bars 801a to 801c, but can be increased or decreased depending on the number of coating layers.

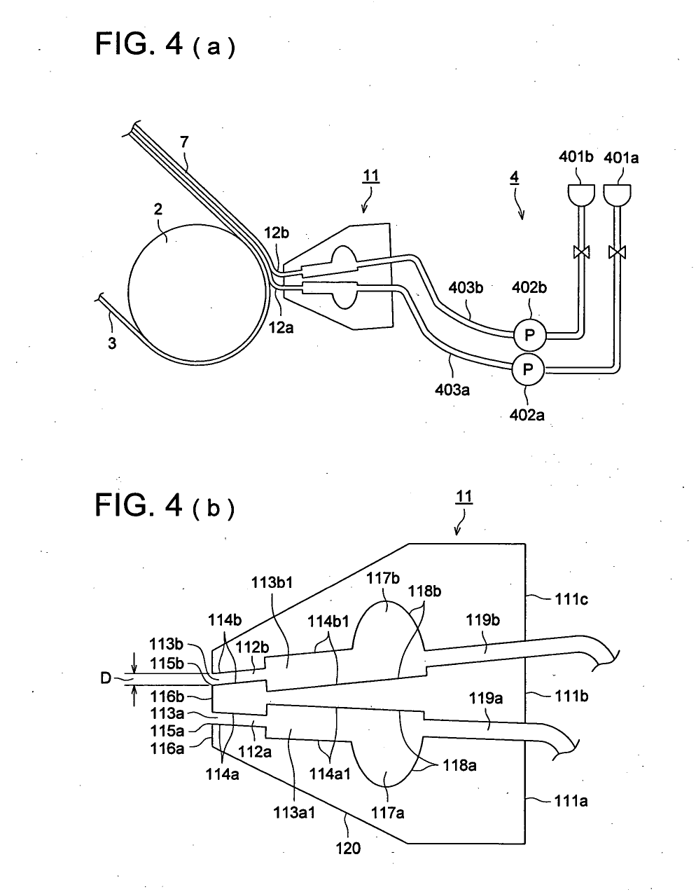

Numerals 802a and 802b represent slit sections that are flow outlets of coating solutions formed between the respective bars 801a to 801c that construct the extrusion type die coater 8. The number of the slit sections is variable depending on the number of bars such as the respective bars 801a to 801c constructing the extrusion type die coater, and typically in a range from 1 to 10. The extrusion type die coater shown in FIGS. 4a and 4b is constructed of 3 bars, having 2 slit sections for simultaneous multi-layer coating.

Numerals 803a and 803b represent inner walls of the respective slit sections 802a and 802b, numerals 804a and 804b represent edge sections at the outlets of the respective slit sections 802a and 802b, and numeral 805a to 805c represent lip sections. Numerals 806a and 806b represent pocket sections formed at the respective slit sections 802a and 802b in order to extrude the coating solutions from the respective slit sections 802a and 802b uniformly in the width direction, the coating solutions having been conveyed from the respective supplying pipes 403a and 403b. Numerals 807a and 807b represent inner walls of the respective pocket sections 806a and 806b.

Numerals 808a and 808b represent coating solution supply flow paths for supplying the coating solutions having been conveyed from the respective supplying pipes 403a and 403b, to the respective pocket sections 806a and 806b. Numeral 809 represents an outer wall continuous with the lip section 805a. When adjusting the flow rates of coating solutions prior to a start of coating or when cleaning the inside of the respective slit sections 802a and 802b, the coating solutions flow down along the outer wall 809, and get dry and solidify, and therefore, the outer wall 809 is a portion that needs cleaning such as rubbing off and scraping off such created solids for each coating.

Surfaces, of the extrusion type die coater shown in FIGS. 2(a) and 2(b), that contact coating solutions according to the invention include the inner walls 803a and 803b of the respective slit sections 802a and 802b, the edge sections 804a and 804b, the inner walls 807a and 807b of the respective pocket sections 806a and 806b, the coating solution supply flow paths 808a and 808b, and the outer wall 809 continuous with the lip section 805a. These surfaces coming in contact with the coating solutions are portions to be coated with a fluorine based resin.

Numerals 810a to 810c represent the bottom surfaces of respective bars 801a to 801c opposing respective lip sections 805a to 805c and these bottom surfaces 810a to 810c construct the bottom surface of the extrusion type die coater 8.

Coating solutions adjusted by adjusting pots 401a and 401b of a coating solution supply system 4 are fed to the respective pocket sections 806a and 806b formed between the bars 801a to 801c through the respective supplying pipes 403a and 403b by respective liquid conveying pumps 402a and 402b, then the coating solutions are extruded from the respective slit sections 802a and 802b, pass through the lip section 805a to 805c, and form beads 9 to be coated on the holding section of the belt-shaped support material 3 that is conveyed in such a way that the surface thereof on the side opposite to the surface to be coated is held by the back-roller 2. Symbol W2 represents a coating point where the coater 8 coats the support material 3 with the coating solutions, wherein the coating point W2 is, in an ordinary case, preferably located at a position downward by 0 to 90 degrees from the horizontal axis that goes through the center of the back-roller. Other symbols represent the same as those in FIGS. 1a and 1b.

When coating is performed for a long time, coating solutions adhere to the lip section 805a and the outer wall 809 which is continuous with the lip section 805a, become dry and solidify, further, foreign materials and silver halide grains mixed in the coating solutions adhere to the inner walls 807a and 807b of the respective pocket sections 806a and 806b, the edge sections 804a and 804b, and the inner walls 803a and 803b of the respective slit sections 802a and 802b. When deposits are pushed out by the coating solutions and coated on the belt-shaped support material as they are, foreign material adhesion failures occur. Also, when foreign materials and silver halide grains mixed in the coating solutions adhere to the inner walls 803a and 803b of the respective slit sections 802a and 802b, the edge sections 804a and 804b, and the lip sections 805a to 805c, the flows of the coating solutions at the portions with deposits become abnormal and turn into streaks which cause streak failures. Further, when a layer created by a dried coating solution adheres to the lip section 805a, bead forming becomes unstable, and accordingly, coating becomes unstable. When a layer created by a dried coating solution adheres to the outer wall 809 that is continuous with the lip section 805a, cleaning after termination of the coating becomes painstaking.

Surfaces, of the extrusion type die coater shown in FIGS. 2(a) and 2(b), that contact coating solutions include the inner walls 803a and 803b of the respective slit sections 802a and 802b, the edge sections 804a and 804b, the inner walls 807a and 807b of the respective pocket sections 806a and 806b, the coating solution supply flow paths 808a and 808b, the lip sections 805a to 805c, and the outer wall 809 continuous with the lip section 805a. These surfaces in contact with the coating solutions are portions to be covered with a fluorine based resin according to the invention. That is, in the extrusion type die coater 8 produced mounting the respective bars 801a to 801d thereon, portions, of the respective bars 801a to 801d, coming in contact with a coating solution are the portions to be covered with a fluorine based resin according to the invention.

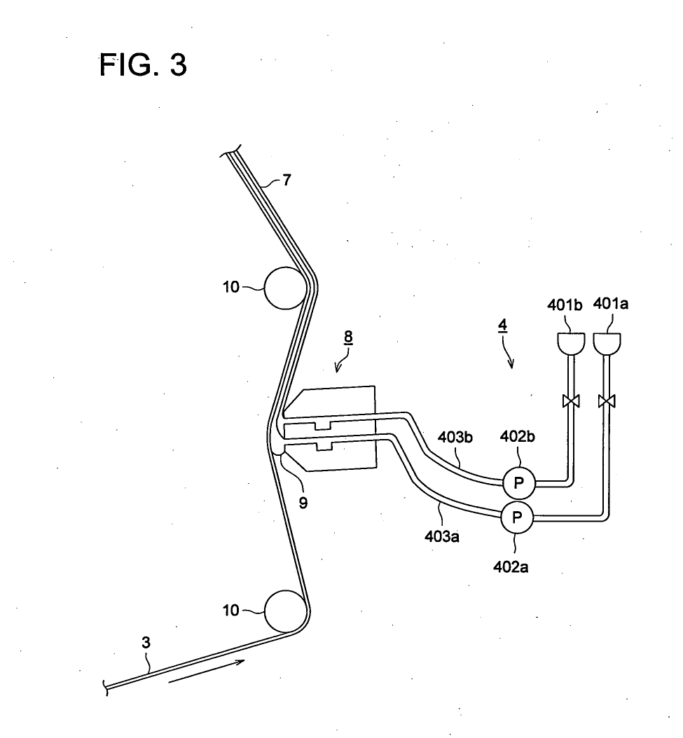

FIG. 3 is a schematic diagram showing an extrusion coating system that performs coating of a support material that is supported by a support roller, using an extrusion type die coater shown in FIGS. 2(a) and 2(b).

Numeral 10 in the figure represents the support roller. Other symbols represent the same as those in FIGS. 2a and 2b. The only difference between the coating system shown in FIG. 3 and in FIG. 2a is that the coating system uses a different method of supporting of the belt-shaped support material, therefore, portions where coating solutions adhere, portions where foreign materials adhere through a long time coating, surfaces in contact with the coating solutions, and portions to be coated with a fluorine based resin are the same as those of the extrusion type die coater shown in FIGS. 2a and 2b.

FIGS. 4a and 4b are schematic diagrams of an extrusion coating system that uses another structure of extrusion type die coater and performs coating by causing a coating solution to collide with an object to be coated at the point to which a predetermined gap is kept from a slit section, instead of forming beads. FIG. 4(a) is a schematic diagram of the extrusion coating system that performs coating on a holding section of a support material having a surface, opposite to a surface to be coated, held by a back roller, using another structure of the extrusion type die coater without forming beads. FIG. 4(b) is an enlarged schematic diagram of the extrusion type die coater shown in FIG. 4(a).

In FIGS. 4a and 4b, numeral 11 represents the extrusion type die coater. The extrusion type die coater 11 is produced having bars 111a to 111c mounted thereon. The number of bars is not fixed by the bars 111a to 111c, but can be increased or decreased depending on the number of coating layers.

Numerals 112a and 112b represent slit sections arranged between the respective bars 111a to 111c which construct the extrusion type die coater. Numerals 12a and 12b represent coating layers formed by ejecting coating solutions from the respective slit sections 112a and 112b.

The number of slit sections is variable depending on the number of bars constructing the extrusion type die coater, and is typically in a range from 1 to 9. The extrusion type die coater shown in FIGS. 4a and 4b is constructed of 3 bars, having 2 slit sections for simultaneous multi-layer coating.

Numerals 113a and 113b represent the coating solution outlet sides of the respective slit sections 112a and 112b, and numerals 113a1 and 113b1 represent the coating solution inlet sides of the respective slit sections 112a and 112b. Numerals 114a and 114b represent inner walls of the respective coating solution outlet sides 113a and 113b of the respective slit sections 112a and 112b, and numerals 114a1 and 114b1 represent inner walls of the respective coating solution inlet sides 113a1 and 113b1. Numerals 115a and 115b represent edge sections of the respective slit sections 112a and 112b, and numerals 116a and 116b represent lip sections. Numerals 117a and 117b represent liquid storing sections formed at the respective slit sections 112a and 112b to extrude the coating solutions from the respective slit sections 112a and 112b uniformly in the width direction, the coating solutions having been conveyed from the respective supply pipes 403a and 403b. Numerals 118a and 118b represent inner walls of the respective liquid storing sections 117a and 117b.

Numerals 119a and 119b represent coating solution supply flow paths for supplying the coating solutions having been conveyed from the respective supplying pipes 403a and 403b, to the respective liquid storing sections 117a and 117b. Numeral 120 represents an outer wall continuous with the lip section 116a. The outer wall 120 is a portion that needs cleaning, specifically, because when adjusting the flow rates of coating solutions prior to a start of coating or when cleaning the inside of the respective slit sections 112a and 112b, the coating solutions flow down along the outer wall 120, and get dry and solidify. Therefore, the outer wall 120 needs cleaning such as rubbing off and scraping off such created solids for each coating.

Numerals 111a to 111c represent the bottom surfaces of respective bars 111a to 111c and these bottom surfaces 111a to 111c construct the bottom surface of the extrusion type die coater 11.

Surfaces, of the extrusion type die coater shown in FIGS. 4a and 4b, that contact coating solutions include the inner walls 114a and 114b of the coating solution outlet sides 113a and 113b of the respective slit sections 112a and 112b, the respective inner walls 114a1 and 114b1 of the coating solution inlet sides 113a1 and 113b1 of the slit sections 112a and 112b, the edge sections 115a and 115b, the lip sections 116a and 116b, the inner walls 118a and 118b of the respective liquid storing sections 117a and 117b, the coating solution supplying flow paths 119a and 119b, and the outer wall 120 continuous with the lip section 116a. These surfaces coming in contact with the coating solutions are portions to be coated with a fluorine based resin. That is, in the extrusion type die coater 11 produced having the respective bars 111a to 111c mounted thereon, portions of the respective bars 111a to 111c coming in contact with a coating solution are the portions to be covered with a fluorine based resin according to the invention.

The coating solutions adjusted by adjusting pots 401a and 401b of a coating solution supply system 4 are supplied to the respective liquid storing sections 117a and 117b arranged between the respective bars 111a to 111c through the respective supply pipes 403a and 403b by liquid conveying pumps 402a and 402b, then the coating solutions are ejected from the respective slit sections 112a and 112b in a layer form so that the coating solutions are made to collide with the holding section of the belt-shaped support material 3 that is conveyed in such a way that the surface thereof on the side opposite to the surface to be coated is held by the back-roller 2, and thus the coating solutions are coated on the holding section of the belt-shaped support material 3.

Symbol D represents an outlet gap of a slit section. The outlet gap D can be properly adjusted depending on the physical properties of a coating solution to be used and the thickness of a coating layer. The gap of the slit section is wider on the inlet side of the coating solution and narrower on the outlet side, wherein the outlet gap D of the slit section is in a range of D≦5×10⁻⁵ [m]. More preferably, D is in a range of 1×10⁻⁵ [m]≦D≦4×10⁻⁵ [m]. The outlet gap D is set in such a range so that the coating solution is ejected in an extremely thin layer form that allows thin layer coating compared with known extrusion type die coaters.

In the case of the extrusion type die coater shown in FIGS. 4a and 4b, portions where foreign materials and silver halide grains adhere in the course of coating for a long time are the same as those of the extrusion type die coater shown in FIGS. 2a and 2b.

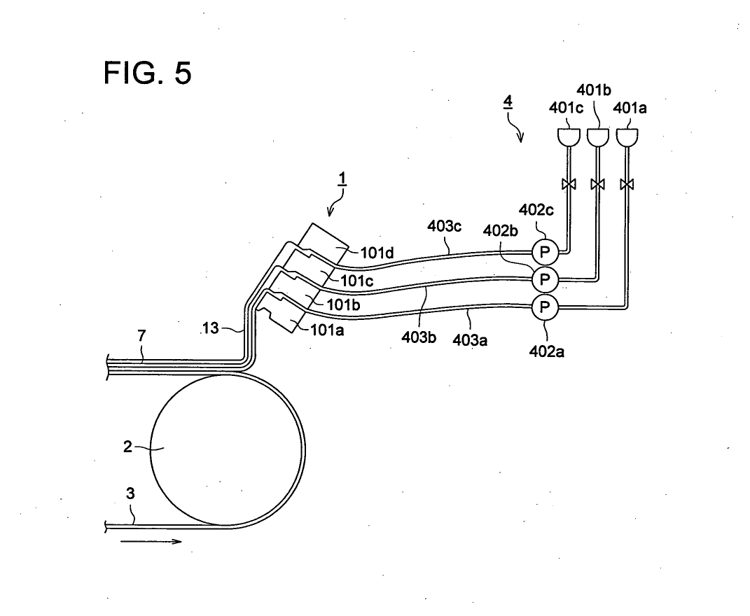

FIG. 5 is a schematic diagram of a curtain coating system using the curtain type die coater.

In FIG. 5, numeral 13 represents layers formed in such a way that coating solutions extruded from the outlets of slit sections flow down along a slide surface in a state the coating solutions are laminated and fall with gravity. The layers 13 are coated on a belt-shaped support material. Other symbols represent the same as those in FIGS. 1a and 1b.

In the case of the slide type die coater shown in FIG. 5, surfaces in contact with coating solutions, portions subjected to covering with a fluorine based resin, and portions where foreign materials and silver halide grains adhere through coating for a long time, are the same as those of the slide type die coater shown in FIGS. 1a and 1b.

In the invention, the slide type die coater, the curtain type die coater and the extrusion type die coaters shown in FIGS. 1a to 5 are also referred to as a die coater to be a generic term.

In the various types of die coaters shown in FIGS. 1a to 5, a pocket section is usually designed to have a large cross section for a low flow velocity so that a coating solution is distributed in a uniform pressure in the coating width direction of coating. In general, therefore foreign materials and silver halide grains in a coating solution easily adhere to a surface of a die coater. Once they have adhered, the depositions turn into a core and grow, and then get torn by some shock to be mixed in the coating solution, causing a coating failure, therefore, covering with a fluorine based resin to prevent adhesion is effective for prevention of the occurrence of the coating failures.

Since a slit section has a narrow gap and the flow velocity of a coating liquid is fast, it may be considered that it is more difficult for foreign materials and silver halide grains to adhere to the slit in the slit section than in the pocket section. However, if foreign materials and silver halide grains in the coating solution adhere to a surface even a little, the flow path is blocked to cause a streak-shape failure, therefore, coating with fluorine based resin to avoid adhesion is effective for prevention of the occurrence of the coating failure.

When the straightness of a slit section is low, it is difficult to eject a coating solution in the width direction of a die coater with a uniform pressure, thus the ejection amount of the coating solution is unstable in the width direction, and the coating layer thickness in the width direction is not constant. Therefore, making the straightness small is effective in achieving a constant coating layer thickness in the width direction.

To prevent adhesion of foreign materials and silver halide grains in a coating solution to a lip section, it is quite effective to cover the lip section with a fluorine based resin as well as in the case of a slit section. Particularly at a lip section, which is on the most downstream side, when a coating solution having come round from beads and deposited gets dry and solidifies, beads cannot be formed stably, and accordingly, stable coating is not allowed, therefore, it is extremely effective to cover with a fluorine based resin for prevention of the deposition to avoid coating failures.

If the straightness of a lip section is low, forming of beads is unstable in the width direction, and it is impossible to perform stable coating and thus the coating layer thickness in the width direction is not constant. Therefore, it is effective to make the straightness small in achieving a constant coating layer thickness in the width direction.

Since a coating solution on a slide surface flows down with gravity, the flow velocity is small and foreign materials and silver halide grains in the coating solution tend to adhere as well as in a pocket section. Therefore, it is extremely effective to cover a fluorine based resin for prevention of the deposition to avoid coating failures.

When the straightness of a slide surface is low, a coating solution flows down on the slide surface unstably, and it is impossible to perform stable coating and thus the coating layer thickness in the width direction is not constant. Therefore, it is effective to make the straightness small in achieving a constant coating layer thickness in the width direction.

An edge is also a part where foreign materials and silver halide grains in a coating solution tend to adhere, and deposition, when occurs, makes a flow of the coating solution unstable to cause a streak failure. Therefore, it is effective to cover with a fluorine based resin for prevention of the deposition to avoid coating failures.

When the straightness of an edge is low, the ejection amount of a coating solution is unstable in the width direction of a slit, and it is impossible to perform stable coating and thus the coating layer thickness in the width direction is not constant. Therefore, it is effective to make the straightness small in achieving a constant coating layer thickness in the width direction.

When adjusting the flow rates of coating solutions prior to a start of coating or when cleaning the inside of respective slit sections, the coating solutions flow down along an outer wall that is continuous with a lip section, adhere, get dry and solidify. The outer wall requires cleaning such as rubbing off and scraping off for each coating. Thus, the outer wall is a portion which takes time to be cleaned. It is effective to cover a fluorine based resin on the outer wall continuous with the lip section for great reduction of the deposition of coating solutions, which shorten the time for cleaning.

In the case of coating for a long time by a die coater that is produced with the bars having been covered with a fluorine based resin at portions thereof coming in contact with a coating solution, the portions of the die coater in contact with a coating solution have less dirt, but, in the case that it is used for a long time, coating with a uniform coating layer thickness in the width direction of coating may not be achieved, which particularly tends to occur on a die coater having a large coating width not smaller than 1 m.

After studies and researches considering the above, the present inventors found the following:

1) When die coater bars to be in contact with a coating solution are coated with a fluorine based resin, the bars are heat-treated to clean the surfaces to be coated and baked to bond the resin to the base. The internal stresses of the bars and the machining stresses of the bars emerge by this baking process. These stresses cause the bars to distort and the straightness of the bars is deteriorated. When the distorted bars are ground to correct the straightness, the grinding stresses remain in the bars. When a die coater having such stressed bars is used for a long time, the latent machining stresses of the bars emerge and make the slit opening uneven along the coating width and make the distance between the die coater and the support material non-uniform. This deteriorates the evenness of layer thickness in the coating width direction.

2) Conventionally, bars are placed on the top of a baking table to bake. However, it has become clear that the straightness of the bars is affected by the straightness of the table top. If the straightness of the table top is lower than that of the bars, the straightness of the bars is deteriorated by transfer of deformation.

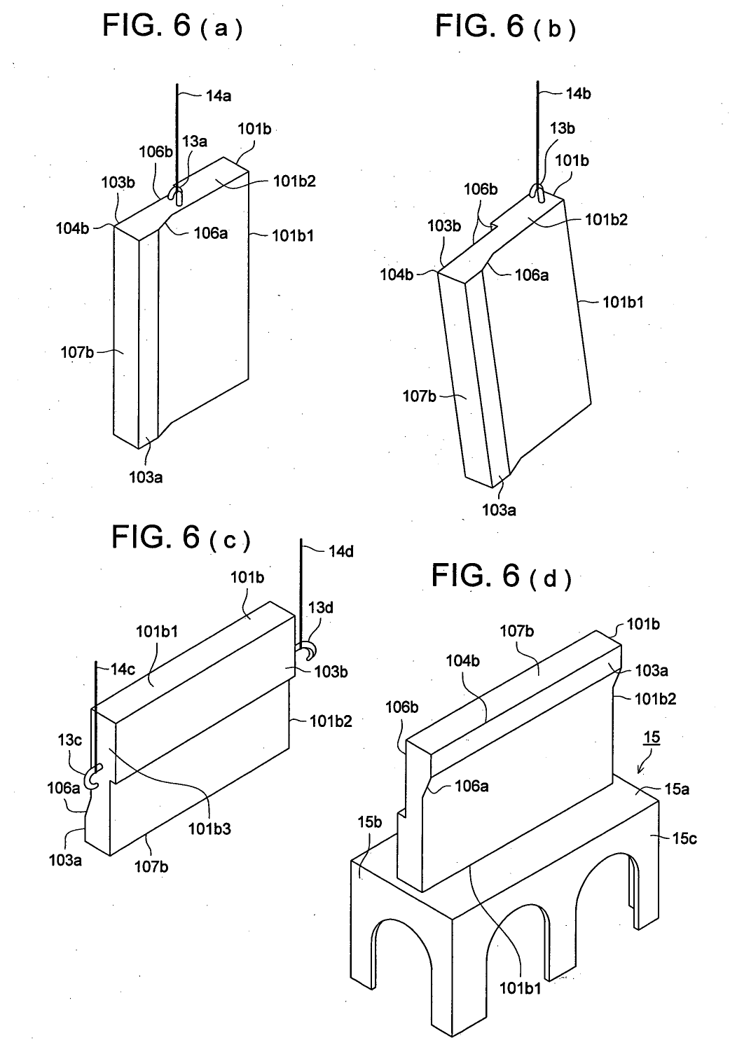

This invention relates to a coating apparatus which uses a die coater equipped with at least two bars of a fixed straightness at least a part of which is coated with a fluorine based resin where it is to be in contact with a coating solution such as in the pocket section which spreads the coating solution in the coating width direction, the liquid supply port which supplies the coating solution to the pocket section, the slit section which discharges the coating solution from the pocket section to a support material, and the external wall connected to the lip sections, and also related to a method of producing the die coater. Below will be explained a method of producing a die coater of this invention. In this invention, the straightness of the die coater includes the straightness of each of the slit section, lip section, slide surface, and edge of the die coater. The straightness of bars includes the straightness of each bar portion which constitutes the slit section, lip section, slide surface, and edge of the die coater. The baking process which follows the fluorine based resin coating process will be explained in reference with FIG. 6.

FIG. 6 is a schematic perspective view of a resin coated bar of a slide type die coater of FIG. 1 after a coating process of a fluorine based resin, which is hung in an furnace for baking with one end face of the bar faced up.

FIG. 6(a) is a schematic perspective view of a bar of a slide type die coater of FIG. 1 which is hung nearly at the center of one end face of the bar which is faced up in a baking furnace for a baking process. FIG. 6(b) is a schematic perspective view of a bar of a slide type die coater of FIG. 1 which is hung at a shifted position on one end face of the bar which is faced up in a baking furnace for a baking process. FIG. 6(c) is a schematic perspective view of a bar of a slide type die coater of FIG. 1 which is hung with the both end faces facing horizontally in an baking furnace for a baking process. FIG. 6 (d) is a schematic perspective view of a bar of a slide type die coater of FIG. 1 which is placed on the top of a baking table with the bottom face of the bar in contact with the table top in a baking furnace for a baking process. The furnace is not illustrated in FIG. 6.

In FIG. 6(a), item 13a is a hook for suspension provided near the center of end face 101b2 (which becomes a side of the die coater when the bar is assembled into the die coater) of bar 101b. Item 14a is a member connected to hook 13a to hang bar 101b. FIG. 6(a) shows that bar is hung with one of its end faces up.

In FIG. 6(b), item 13b is a hook for suspension provided at one end of end face 101b2 of bar 101b. Item 14b is a member connected to hook 13b to hang bar 101b. FIG. 6(b) like FIG. 6(a) shows that bar 101b is hung with one of its end faces up.

In FIG. 6(c), item 13c is a hook for suspension provided near the center of end face 101b3 (which becomes a side of the die coater when the bar is assembled into the die coater) of bar 101b. Item 13d is a hook for suspension provided near the center of end face 101b2 (which becomes a side of the die coater when the bar is assembled into the die coater) of bar 101b. Item 14c is a member connected to hook 13c to hang bar 101b. Item 14d is a member connected to hook 13d to hang bar 101b. FIG. 6(c) shows that bar is hung by hooks provided on both end faces with the both end faces facing horizontally. The example of FIG. 6(c) is provided for comparison with the suspension methods of FIG. 6(a) and FIG. 6(b).

FIG. 6(d) will now be explained. Item 15 is a baking table on which bar 101b is placed. Item 15a is the top surface of table 15 on which bar 101b is placed. On both long and short sides of table top 15a, table 15 has side walls which also work as table legs. Item 15b is a side wall on the shorter side of the table top and item 15c is a side wall on the longer side of the table top. FIG. 6(d) is a schematic perspective view of a die coater bar which is placed on table top 15a of a baking table 15 with its end face, which becomes the bottom face 101b1 of a slide type die coater when the bar is assembled into the slide type die coater, in contact with the table top 15a. The example of FIG. 6(d) is provided for comparison with the suspension methods of FIG. 6(a) and FIG. 6(b).

Members 14a to 14d can be any type as long as they can hold the weight of the bar. They are for example, steel chains and wires. In FIG. 6, wires are used as members 14a to 14d. Further, the hooks for suspension can be provided on any place as long as an end face is faced up. It is preferable that the end face extends as horizontally as possible (in which the longer side (along the coating width) is in the direction of gravity) because the bar is stable in this status. In this status, the status in which one of the end faces of the bar is faced up indicates that the end face of the bar is tilted within 45 degrees relative to the horizontal line and preferably that the end face is held to extend as horizontally as possible in which the longer side (along the coating width) is in the direction of gravity). In FIG. 6 and FIG. 1, like parts are designated by like reference numbers.

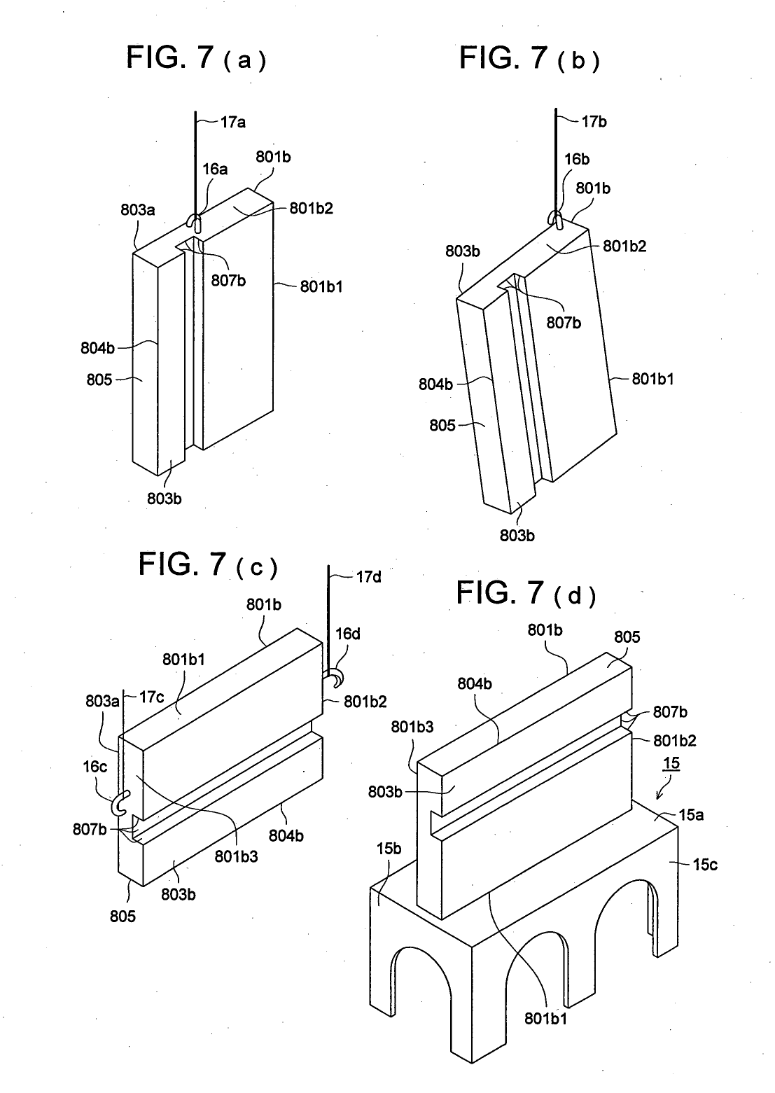

FIG. 7 is a schematic perspective view of a resin coated bar of an extrusion type die coater of FIG. 2 after a coating process of a fluorine based resin, which is hung in an furnace for baking with one end face of the bar faced up and the hanging point near the center. FIG. 7(a) is a schematic perspective view of a bar of an extrusion type die coater of FIG. 2 which is hung nearly at the center of one end face of the bar which is faced up in a baking furnace for a baking process. FIG. 7(b) is a schematic perspective view of a bar of an extrusion-type die coater of FIG. 2 which is hung at a shifted position on one end face of the bar which is faced up in a baking furnace for a baking process. FIG. 7(c) is a schematic perspective view of a bar of an extrusion type die coater of FIG. 2 which is hung with the both end faces facing horizontally in an baking furnace for a baking process. FIG. 7 (d) is a schematic perspective view of a bar of an extrusion type die coater of FIG. 2 which is placed on the top of a baking table with the bottom face of the bar in contact with the table top in a baking furnace for a baking process. The furnace is not illustrated in FIG. 7.

In FIG. 7(a), item 16a is a hook for suspension provided near the center of end face 801b2 (which becomes a side of the die coater when the bar is assembled into the die coater) of bar 801b. Item 17a is a member connected to hook 16a to hang bar 801b. FIG. 7(a) shows that bar is hung with one of its end faces up.

In FIG 7(b), item 16b is a hook for suspension provided at one end of end face 801b2 of bar 801b. Item 17b is a member connected to hook 16b to hang bar 801b. FIG. 7(b) like FIG. 7(a) shows that bar 101b is hung with one of its end faces up.

In FIG. 7(c), item 16c is a hook for suspension provided near the center of end face 801b3 (which becomes a side of the die coater when the bar is assembled into the die coater) of bar 801b. Item 16d is a hook for suspension provided near the center of end face 801b2 (which becomes a side of the die coater when the bar is assembled into the die coater) of bar 801b. Item 17c is a member connected to hook 16c to hang bar 801b. Item 17d is a member connected to hook 16d to hang bar 801b. FIG. 7(c) shows that bar is hung by hooks provided on both end faces with the both end faces facing horizontally. The example of FIG. 7(c) is provided for comparison with the suspension methods of FIG. 7(a) and FIG. 7(b).

FIG. 7(d) will now be explained. FIG. 7(d) is a schematic perspective view of a die coater bar which is placed on table top 15a of a baking table 15 with its end face, which becomes the bottom face 801b1 of an extrusion type die coater when the bar is assembled into the extrusion type die coater, in contact with the table top 15a. The example of FIG. 7(d) is provided for comparison with the suspension methods of FIG. 7(a) and FIG. 7(b).

Members 17a to 17d can be any type as long as they can hold the weight of the bar. They are for example, steel chains and wires. In FIG. 7, wires are used as members 17a to 17d. Further, the hooks for suspension can be provided on any place as long as an end face is faced up. It is preferable that the end face extends as horizontally as possible (in which the longer side (along the coating width) is in the direction of gravity) because the bar is stable in this status. In FIG. 7 and FIG. 2, like parts are designated by like reference numbers.

The bars constituting each die coater shown in FIGS. 1 to 5 are suspended when they are high-treated by a heat treatment furnace after a coating process of the fluorine based resin, according to the method illustrated in FIGS. 6 and 7. This arrangement allows the bars to be heated and cooled without the bars coming into contact with other solids located nearby. This will ensure uniform expansion and shrinkage of all the surfaces of the bars, and eliminates the possibility of causing deflection or torsion. Force is applied in such a way that, if there is a curvature, the bars are pulled straight by gravity, with the result that the curvature of the bars is improved. This provides bars characterized by superb straightness. As a result, the amount of grinding work is reduced in the step of grinding subsequent to heat treatment, and therefore the residual amount of grinding stress is reduced. The bars produced in this manner are assembled to produce the die coater. Such a die coater is impervious to any variation in the straightness that may adversely affect the property of coating after the lapse of a long time and thus, stable coating is ensured. In particular, this arrangement reduces the strain of the die coater having a broad width of 1 m or more, wherein reduction of the strain is difficult when the prior art is used. The die coater having a broad width of 1 m or more is a die coater having a coating width of 1 through 4 m in this invention.

After the finish grinding process of bar that has been coated with a fluorine based resin in accordance with this invention, the straightness of the coated portion of the bar is preferably 0.1 to 10 μm and the surface roughness of the fluorine based resin coated area of the bar is preferably 0.01 μm<Ra<1 μm and 0.1μm<Rmax<5 μm. The straightness of less than 0.1 μm is hard to be obtained because it is a limit of accuracy in grinding. If the straightness exceeds 10 μm, the die coater cannot discharge a coating solution steadily and as the result, the thickness of the layers may not be even.

Since the parts of bars which are coated with fluorine based resin are ground to have such straightness, the die coater can supply a coating solution steadily in the width direction for a long time so that stable coating of layers in the width direction becomes possible.

In this invention, the straightness means the straightness (per meter) of a bar surface along the coating width. It can be measured by placing the bar on a precision surface grinding machine, making the feeler of a dial gauge in contact with a test part of the bar, fixing the dial gauge, and moving the precision surface grinding machine. Die coater bars can be ground by a generally-used precision surface grinding machine. If the surface roughness Ra of a bar is less than 0.01 μm, the bar is hard to be ground and the straightness of a resin-coated part may be deteriorated. If the surface roughness Ra is greater than 1 μm, the surface may be apt to attract foreign materials and silver halide grains which are in the coating solution and the effect of coating the bar with a fluorine based resin may be reduced.

When the surface roughness Rmax is less than 0.1 μm, the bar is hard to be ground and the straightness of a resin coated part may be deteriorated. If the surface roughness Rmax exceeds 5 μm, the surface may be apt to attract foreign materials and silver halide grains which are in the coating solution and the effect of coating the bar with a fluorine based resin may be reduced.

The surface roughness in the above range can protect the bar against deposition of foreign objects and silver halide grains from the coating solution even after a long-time coating and improve the flow of the coating solution. As the result, the die coater made of such bars can form a coated layer of a uniform thickness without causing a coating failure. The bars can be ground by a grinding machine or by hands with polishing powders.

The following measure can be provided to reduce distortions of bars caused from a fluorine based resin coating.

The measure is to heat bars before coating the bars with a fluorine based resin. The preheating temperature is preferably equal to or higher than the resin baking temperature in order to reduce distortions of bars caused by a coating process with a fluorine based resin and to cause the internal stresses and machining stresses of the bars to emerge and generate distortions. If the preheating temperature is lower than the resin baking temperature, the internal stresses and grinding stresses of the bars will emerge during baking of the bars after coating with a fluorine based resin. As the result, the bar distortions may become greater.

Since preheating of bars constructing a die coater can eliminate the internal stresses and grinding stresses of the bars, distortions of the resin coated bars can be suppressed in the baking process of the fluorine based resin coated bars. Thus, this can reduce the quantity of finish grinding and the quantity of grinding stresses left in the ground bars. The die coater having such bars, therefore, can produce layers of a fixed thickness in the coating width direction even after a long time operation without changing the straightness. This method is also effective to suppress distortions of bars for a broad width type die coater (whose coating width is 1 meter or longer) for which it was difficult to suppress the distortions conventionally. Particularly, this method is effective to die coaters whose coating width is 1 to 4 meters long.

The maximum preheating temperature is dependent on materials of bars which constitute the die coater and hard to be determined. However, the maximum preheating temperature should be lower than the melting point of the bars.

Another measure is to bake the resin coated bars at a temperature as low as possible while keeping the strength of the fluorine based resin layer. Conventionally, bars coated with a fluorine based resin are normally baked at 400 to 500° C. Such temperatures will cause emergence of distortions which could not be removed by the above preheat treatment process and the succeeding grinding process and also distortions due to machining stress made by the grinding process following the preheat treatment process. These distortions deteriorate the straightness of the bars. Further, finish grounding to correct the straightness of the bars will increase the residual machining stresses of the bars. If the bars having such latent machining stresses are assembled into a die coater, the latent machining stresses will emerge as the die coater is used for a long period, and the straightness of the resin coated parts will deteriorate. This makes the slit opening uneven along the coating width and makes the distance between the die coater and the support material non-uniform. This deteriorates the evenness of layer thickness in the coating width direction.

To re-strengthen the fluorine based resin layer which becomes weaker by baking at a lower temperature, a method to reduce the baking temperature without deteriorating the strength of the fluorine based resin layer was studied and the inventors found that it was preferable to use it as a coating compound system which has a fluorine based resin dispersed in a thermosetting resin.

As a fluorine based resin according to this invention, those generally used can be used. The fluorine based resin is not limited to a specific one. For example, a polytetrafluoroethylene (PTFE), a tetrafluoroethylene-perfluoroalkylvinylether copolymer (PFA), a tetrafluoroethylene-hexafluoropropylene copolymer (FEP), an ethylene-tetrafluoroethylene copolymer (ETFE), a polychlorotrifluoro ethylene copolymer (PCTFE), a chlorotrifluoroethylene-ethylene copolymer (ECTFE), a polyvinyl fluoride (PVF), a polyvinylidene fluoride (PVDF), etc. may be usable.

Especially, among these fluorine based resin, FEP, ETFE, and ECTFE are excellent in solvent resistance, scratch resistance, and abrasion resistance, and, moreover, can be baked at low temperature compared to other fluorine based resins. Therefore, the above-mentioned resins are employed as a desirable fluorine based resin for the coating to the die coater according to this invention.

As a thermosetting resin, for example, a phenol resin (PF), a urea resin (UF), a melamine resin (MF), an epoxy resin (EP), a unsaturated polyester resin (UP), a diallylphthalate resin (PDAP), a polyimide resin (PI), polyamide-imide resin (PAI), a silicone resin (SI), etc. may be listed. As a desirable thermosetting resin, PAI may be listed especially. It became possible to make a temperature of a baking process lower by using such a thermosetting resin.

The bars coated with a fluorine based resin should be baked preferably at 100 to 380° C. If the baking temperature is lower than 100° C., enough strength of the fluorine based resin layer is not obtained and it may fall off to cause a coating failure during a coating operation. When the baking temperature exceeds 380° C., the die coater will have distortions and to correct the distortions, the distorted bars must be finish-ground with a large grinding amount, resulting in increase of the residual grinding stresses in the bars. Therefore, if a die coater having such stressed bars is used for a long time, the straightness of slit openings and pocket sections may be deteriorated and the thickness of the coated layer may be uneven.

The resin baking temperature of 100 to 380° C. is effective to prevent distortions of bars due to baking. This temperature along with a preheat treatment process enables the die coater to provide a coated product with a coated layer of an even thickness in the coating width direction without coating failures. This invention can provide a die coater whose portions to be in contact with a coating solution are coated with a fluorine based resin and a coating apparatus which uses the die coater.

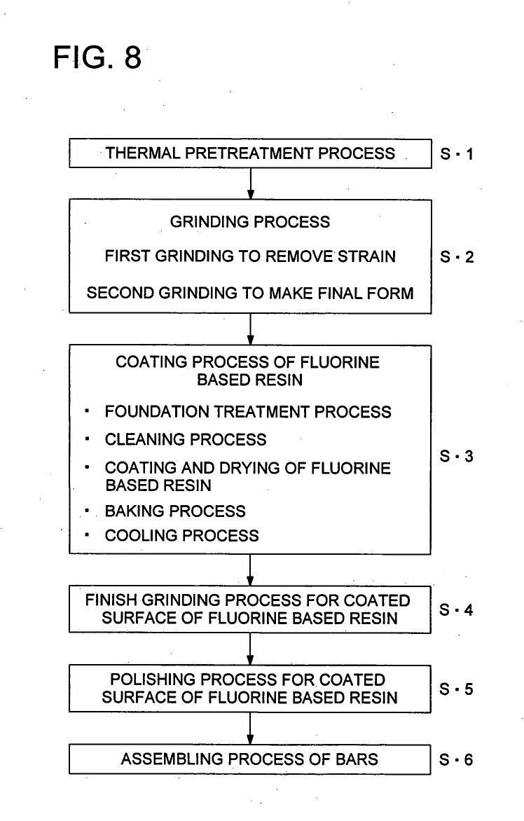

A method of producing a die coater of this invention will be explained with reference to FIG. 8.

FIG. 8 shows an example of schematic flow diagram of producing a die coater whose parts to be in contact with a coating solution are coated with a fluorine based resin.

This flow diagram shows the case where portions of bar constituting a die coater to be in contact with a coating solution are coated with a fluorine based resin after the bar is preheated at a temperature equal to or higher than the resin baking temperature.

The production of a die coater whose portion to be in contact with a coating solution are coated with a fluorine based resin includes steps of preheating bars forming the die coater (S-1), grinding the preheated bars (S-2), coating the bars with a fluorine based resin (S-3), finish grinding fluorine based resin coated surfaces (S-4), polishing the fluorine based resin coated surfaces (S-5), and assembling the bars into the die coater (S-6).

It is possible to coat portions (to be in contact with a coating solution) of the bar with a fluorine based resin without steps S-1 (preheating bars forming the die coater) and S-2 (grinding the preheated bars). However, with the use of steps S-1 and S-2, the bar parts can be coated with a fluorine based resin at a higher accuracy. Each step will be described below.

The step S-1 of preheating a bar which constitutes a die coater is carried out before the bar is coated with a fluorine based resin to cause the latent internal and machining stresses of the bar to emerge and to cause the bar to have a distortion. Therefore, to suppress generation of distortions on the bar in the succeeding step, the preheating temperature should preferably be equal to or higher than the baking temperature of the fluorine based resin. The maximum preheating temperature is dependent on materials of bars which constitute the die coater and hard to be determined. However, the maximum preheating temperature should be lower than the melting point of the bars.

The grinding step S-2 contains

1) a first grinding step to remove bar distortions caused in the preheating treatment step S-1 and

2) a second grinding step to finish-grind to obtain the final profile of the bar.

The first grinding step to remove bar distortions enables reduction of the quantity of finish grinding after the coating of a fluorine based resin. The second grinding to obtain the final profile means a grinding to a designed shape which is given in the design drawing. It frequently occurs that bars are repeatedly ground to satisfy the required dimensional accuracy (to the accuracy of micrometers) and in extreme cases, a total thickness of the resin coatings on the bars may be ground off. This problem can be solved by finish-grinding the bars before coating the bars with a fluorine-based resin. With this, the bars can be ground to the designed shapes without grinding off a total thickness of coated resin layers.

The coating process of fluorine based resin of S-3 includes five processes of 1) a foundation treatment process that makes the fluorine based resin coating surfaces of the bar rough by sandblast or the like, prior to coating of the fluorine based resin in order to give excellent adherability and prevent peeling after coating of the fluorine based resin, 2) a cleaning treatment of the surface to be coated with the fluorine based resin (sweeping process, burning process), 3) a coating process of the fluorine based resin (coating, dipping) and drying, 4) a baking process to strengthen of the fluorine based resin layer and adhesive power, and 5) a cooling process. Through these five processes, it becomes possible to obtain a layer of the desired thickness by repeating theses processes according to the necessity.

When the bars are burnt for cleaning, the burning temperature needs to be equal to or lower than the baking temperature. If the burning temperature is higher than the baking temperature, the bar may have a greater distortion than that is caused in the baking process and the bar must be ground too much to correct the distortion. Consequently, the bar has a greater grinding stress left in it.

In the baking process, the bars coated with a fluorine based resin are hung perpendicularly (in the direction of gravity). (See FIGS. 6 and 7 for the hanging condition of bars for baking.) The baking temperature is preferably 100 to 380° C.

Regarding the thickness of the fluorine based resin layer when coated with the fluorine based resin, because deformation can be restrained during coating with the fluorine based resin by performing a preheating process and maintaining the temperature of the baking process to be 100 to 380° C., a finish grinding with a small grinding amount becomes sufficient after the fluorine based resin coating process. Therefore, it is possible to make a thickness of the fluorine based resin coating layer in the coating process thinner such as 0.3 mm or less. However, in the case where the coating layer is thinner than 0.03 mm, the fluorine based resin coating may be lost by finish grinding on the surface of the fluorine based resin coating, which requires careful attention for the prevention. Further, the thickness of coating layer can be exceed 0.3 mm, however an excessive thickness raise the cost depending on the type of the fluorine based resin.

In the case that no preheating is carried out, it is necessary to increase the thickness so as not to lost the fluorine based resin by the grinding removal, after the coating, of deflection or torsion through bar distortion caused by the baking process temperature. Therefore, the coating layer of the fluorine based resin is preferably 0.3 mm or more. The grinding within a thickness of the fluorine based resin including an extra thickness finally makes it possible to obtain necessary straightness, surface roughness and shape on the portion coated with the fluorine based resin. When the thickness of the coating layer is less than 0.3 mm, there is the case that the fluorine based resin coating is lost before complete removal of deflection or torsion through bar distortion during a grinding on a fluorine based resin coating surface. On the other hand, when the thickness exceeds 1 mm, there is also the case of a cost rise by the unnecessary thickness depending on the type of fluorine based resin.

The finish grinding step S-4 to finish-grind the fluorine based resin coated surfaces of the bar includes the first finish grinding step to remove uneven thickness of a fluorine based resin coating formed on the bar, and the second finish grinding step to correct the straightness of fluorine based resin coated portions in the coating width direction to the required straightness. These processes of finish grinding to the portions which are coated with a fluorine based resin can eliminate bar distortions caused by heat treatment in the resin coating process S-3, correct the thickness of the coated layer of the fluorine based resin to be uniform, and correct the straightness of portions which are in contact with a coating solution to be uniform. Therefore, the die coater can form layers of a uniform thickness.

The S-5 step of polishing the fluorine based resin coated surfaces is to polish the surfaces coated with a fluorine based resin to have surface roughness of 0.01 μm<Ra<1 μm and 0.1 μm<Rmax<5 μm. The polishing process can be done by a grinding machine or by hand with a polishing powder.

The S-6 step of assembling the finished bars into a die coater is to assemble the fluorine based resin coated bars which are produced by steps S-1 to S-5 into a die coater.

By the method of producing a die coater, shown in FIGS. 6 to 8, according to the invention, various die coaters, shown in FIGS. 1 to 5, have advantages including 1) acquiring bars with excellent straightness and reduced remaining stresses caused by finish grinding, which is produced by restraining distortion caused by coating process of bars forming a die coater, with a fluorine based resin and reducing the amount of finish grinding, 2) enabling fluorine based resin coating of the portions, of the die coater, coming into contact with a coating solutions with accuracy, 3) achieving a stable straightness of the die coater due to being free from variation of the straightness of bars which construct a die coater even for a long elapsed time and preventing foreign materials and silver halide grains in the coating solution from depositing on the portions in contact with the coating solution even for a long time coating. Thus, a coating apparatus is achieved that employs a die coater which attains an excellent coating quality with a uniform thickness in the width direction of coating and few coating failures while keeping the cleanability of known die coaters. The method of producing a die coater of the invention is effective for die coaters for performing broad coating with a width of 1 m or larger, and particularly effective for die coaters for performing broad coating with a width ranging from 1 to 4 m.

A support material to be used in practicing the invention is not limited in type, and for example, a paper sheet, plastic film, a metal sheet, a glass board and a metal board can be used. As paper, resin coat paper and synthetic paper can be applied, for example. As plastic film, polyolefin film (for example polyethylene film, polypropylene film), polyester film (for example, polyethylene terephthalate film, 2,6-polyethylene naphthalate film), polyamide film (for example polyeter ketone film), cellulose acetate (for example cellulose triacetate) may be usable. As metal sheets, aluminum plates are representatives. Further, there is no particular limit on the thickness of a support material to be employed.

A coating solution to be employed in practicing the invention is not limited particularly, and it is allowed to use, for example, coating solutions for photographic photosensitive materials, thermal development recording materials, abrasion recording materials, magnetic recording media, steel plate surface treatment, and electrophotographic photoreceptors (including coating solutions for undercoating, over coating, and back coating). Among these, particularly preferable are coating solutions for light-sensitive layers which are coating solutions for thermal development photosensitive materials and contain a silver component, and coating solutions for non-light-sensitive protective layers.

### EXAMPLES

The present invention will now be described with reference to examples. However, the present invention is not limited thereto.

### Example 1

A light-sensitive layer coating solution containing organic silver and surface protective coating solution were prepared based on the method described below.

<Light-Sensitive Layer Coating Solution>

<<Preparation of Silver Halide Emulsion A>>

7.5 g of inert gelatin and 10 mg of potassium bromide were dissolved in 900 ml of water and the resulting solution was maintained at 35° C. and the pH was adjusted to 3.0. Thereafter, 370 ml of an aqueous solution containing 74 g of silver nitrate and 370 ml of an aqueous solution containing potassium bromide and potassium iodide at a mol ratio of (98/2), as well as an [Ir(NO)Cl₅] salt in an amount of 1×10⁻⁶ mol with respect to 1 mol of silver, and rhodium chloride in an amount of 1×10⁻⁶ mol with respect to 1 mol of silver were added employing a controlled double jet method while maintaining pAg at 7.7. Thereafter, 4-hydroxy-6-methyl-1,3,3a,7-tetraazaindene was added and the pH of the resulting mixture was adjusted to 5 by the addition of NaOH, whereby cubic silver iodobromide grains at an average grain size of 0.06 μm, a degree of monodispersion of 10 percent, a variation coefficient of the projected diameter area of 8 percent, and a [100] plane ratio of 87 percent were prepared. The resulting emulsion was coagulated employing gelatin coagulants, and then desalted, thereafter, 0.1 g of phenoxyethanol was added and the pH and pAg of the resulting mixture were adjusted to 5.9 and 7.5, respectively, whereby a silver halide emulsion was prepared. In addition, the resulting silver halide emulsion underwent chemical sensitization employing chloroauric acid and inorganic sulfur, whereby Silver Halide Emulsion A was prepared.

The above-mentioned degree of monodispersion and variation coefficient of projected diameter area were calculated employing the formulas below:
Degree of monodispersion (in percent)=(standard deviation of grain diameter)/(average value of grain diameter)×100
Variation coefficient of projected diameter area (in percent)=(standard deviation of projected diameter area)/(average value of projected diameter area)×100
<<Preparation of Sodium Behenate Solution>>

32.4 g of behenic acid, 9.9 g of arachidic acid, and 5.6 g of stearic acid were dissolved at 90° C. in 945 ml of pure water.

Subsequently, under vigorous stirring, 98 ml of a 1.5 mol/L aqueous sodium hydroxide solution was added.

After adding 0.93 ml of concentrated nitric acid, the resulting mixture was cooled to 55° C. and stirred for 30 minutes, whereby a sodium behenate solution was prepared.

(Preparation of Pre-Formed Emulsion)

15.1 g of the aforesaid Silver Halide Emulsion A was added to the above-mentioned sodium behenate solution, and the pH of the resulting mixture was adjusted to 8.1 by the addition of sodium hydroxide. Thereafter, 147 ml of a 1 mol/L silver nitrate solution was added to the solution over a period of 7 minutes. The resulting mixture was stirred for an additional 20 minutes, and water-soluble salts were removed utilizing ultrafiltration.

The resulting silver behenate includes particles at an average particle size of 0.8 μm and a degree of monodispersion of 8 percent. After forming flocks of the dispersion, water was removed. Thereafter, water washing was repeated 6 times, and water was then removed, followed by drying. Subsequently, 544 g of a methyl ethyl ketone solution (17 percent by weight) of polyvinyl butyral (at an average molecular weight of 3,000) and 107 g of toluene were gradually added and stirred, then, the resulting mixture was dispersed at 27.6 MPa, employing a media homogenizer, whereby a pre-formed emulsion was prepared.

| <Preparation of Light-sensitive Layer Coating Solution> | | |
|---|---|---|
| Pre-formed emulsion | 240 | g |
| Sensitizing Dye 1 (0.1 percent methanol solution) | 1.7 | ml |
| Pyridiniumpromideperbromide (6 percent methanol solution) | 3 | ml |
| Calcium bromide (0.1 percent methanol solution) | 1.7 | ml |
| Antifogging Agent 1 (10 percent methanol solution) | 1.2 | ml |
| 2-(4-chlorobenzoylbenzoic acid (12 percent methanol solution) | 9.2 | ml |
| 2-mercaptobenzimodazole (1 percent methanol solution) | 11 | ml |
| Tribromomethylsulfoquinoline (5 percent methanol solution) | 17 | ml |
| Developing Agent 1 (20 percent methanol solution) | 29.5 | ml |

[Chem. 1]
Sensitizing Dye 1

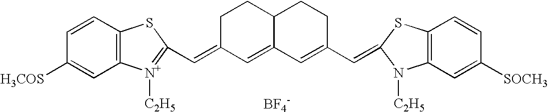

Antifogging Agent 1

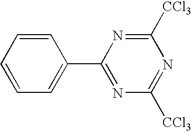

Developing Agent 1

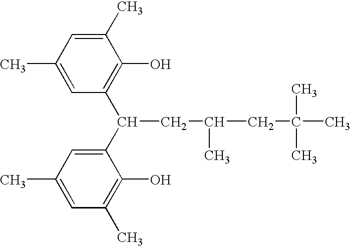

<Surface Protective Layer Coating Solution>

<<Preparation of Surface Protective Layer Coating Solution>>

| | | |
|---|---|---|
| Acetone | 35 | ml/m² |
| Methyl ethyl ketone | 17 | ml/m² |
| Cellulose acetate | 2.3 | g/m² |
| Methanol | 7 | ml/m² |
| Phthalazine | 250 | mg/m² |
| 4-methylphthalic acid | 180 | mg/m² |
| Tetrachlorophthalic acid | 150 | mg/m² |
| Tetrachlorophthalic anhydride | 170 | mg/m² |
| Matting agent: monodipsersed silica at a | 70 | mg/m² |
| degree of monodispersion of 10 percent | | |
| and an average particle size of 4 μm | | |
| C₉H₁₉—C₆H₄—SO₃Na | 10 | mg/m² |

<Preparation of a Die Coater>

Slide type die coaters of FIG. 1 was produced by the following method and assigned numbers of No. 1-1 to No. 1-9 to them. When producing the die coaters, stainless-steel (SUS630) bars having a longer side of 2000 mm long and a straightness of 1 μm were prepared, and coated respectively with a fluorine based resin while changing portions to be coated as shown in Table 1. Further, the coated bars were baked at 300° C. under bar-suspension conditions shown in Table 1, and each baked bar were finish-ground to have the original straightness before baking, and then the finish-ground bars were polished to have surface roughness of 0.1 μm as Ra and 0.5 μm as Rmax, and finally assembled into slide type die coaters.

The bars were burnt at 300° C. to clean the surfaces to be coated before coating the bars with a fluorine based resin. ETFE was used as the fluorine based resin and bars were coated with a layer of 300 μm thick.

A columnar type precision surface grinding machine manufactured by Okamoto Machine Tool Works Ltd was used for grinding. The straightness of each bar was measured by fixing a commercially available laser displacement sensor to the stone holder of the grinding machine with a magnet stand, linearly moving the bar which is-placed on the grinding machine in parallel with the machine movement, measuring horizontal displacements of the vertical face of the bar over the whole length of the bar, and calculating the difference between the maximum and minimum values per 1 meter of the bar.

Surftest SJ-201P manufactured by Mitutoyo Corp. was used to measure surface roughness Ra and Rmax and a capacitance type microdisplacement detector manufactured by Ono Sokki Co., Ltd. was used to measure thicknesses of resin coat thickness of fluorine based resin. The portion to be coated with a fluorine based resin is indicated by a functional name of the bar on the die coater into which the bar is assembled. After finish grinding and polishing were completed, the completed bars were assembled into slide type die coaters No. 1-1 and 1-9 and starts to be used immediately and used for one year

TABLE 1

| | | Portions coated with fluorine based resin | | | | | |
|---|---|---|---|---|---|---|---|
| | | | | | | External | |
| | Bar | | | | | wall | |
| | suspension | Internal | Internal | | | surface | |
| Die | method for | wall of | wall of | | Lip and | linked | |
| coater | heat | slit | pocket | Slide | edge | with lip | |
| No. | treatment | section | section | surface | sections | section | Remarks |
| 1-1 | A | Coated | Coated | Coated | Coated | Coated | Embodiment |
| 1-2 | A | Coated | Coated | Coated | Coated | Not | Embodiment |
| | | | | | | coated | |
| 1-3 | A | Coated | Coated | Coated | Not | Not | Embodiment |
| | | | | | coated | coated | |
| 1-4 | A | Coated | Coated | Not | Not | Not | Embodiment |
| | | | | coated | coated | coated | |
| 1-5 | A | Coated | Not coated | Not | Not | Not | Embodiment |
| | | | | coated | coated | coated | |
| 1-6 | — | Not | Not coated | Not | Not | Not | Comparative |
| | | coated | | coated | coated | coated | example |
| 1-7 | B | Coated | Coated | Coated | Coated | Coated | Embodiment |
| 1-8 | C | Coated | Coated | Coated | Coated | Coated | Comparative |
| | | | | | | | example |
| 1-9 | D | Coated | Coated | Coated | Coated | Coated | Comparative |
| | | | | | | | example |

In Table 1, symbol A indicates suspension methods of FIG. 6(a), symbol B indicates suspension methods of FIG. 6(b) and symbol C indicates suspension methods of FIG. 6(c) and then symbol D indicates methods of placing a bar on a baking table as shown in FIG. 6(d). Bars of die coater No. 1-6 were not heat-treated because the bars were not coated with a fluorine based resin.

<Coating>

Employing each of die coaters 1-1 to 1-9 which had been just produced and each of die coaters 1-1 to 1-9 which had been used for one year, viscosity μ (Pa.s) of the light-sensitive layer coating solution prepared as above was adjusted to approximately 0.5 Pa.s, while viscosity μ (Pa.s) of the protective layer coating solution was adjusted to approximately 1.0 Pa.s. Subsequently, the resulting coating solutions were applied by coating with a coating width of 1,900 mm at a coating rate of 30 m/minute onto a support material which was prepared by connecting 10 belt-shaped support materials (made of PET) at a thickness of 175 μm, a width of 2,100 mm and each length of 1,000 m, so that a light-sensitive layer was arranged as a lower layer at a coated weight of 75 g/m² (wet weight), and the protective layer was arranged as an upper layer at a coated weight of 25 g/m² (wet weight), and resulting coating solution was dried, whereby samples were prepared. Viscosity was measured employing ROTOVISCO RV-12 of Haake, Inc. and viscosity at each shearing was measured. The pipes covered with a fluorine based resin (FEP) were employed in a coating solution supply path section.

<Evaluation>

Layer samples were provided by die coaters Nos. 1-1 to 1-9 immediately after the die coaters were produced and these after one-year service, and the number of generated streaks and the distribution of layer thicknesses in the coating width direction of each layer sample were measured. Table 2 lists the results of the measurement. The coating layer thickness distribution in the width direction was evaluated based on the evaluation rankings described below. The coating layer thickness distribution in the width direction was obtained such that the coating layer thickness at the end of the coating was recorded at an interval of 50 mm across the width, and the ratio of the difference between the maximum value and the minimum value to the average value was calculated and expressed as a percentage. The coating layer thickness was measured as follows, while employing an electrical micrometer MINICOM M, manufactured by Tokyo Seimitsu Co., Ltd. Total thickness at one point of a sample was measured, thereafter, the coating layer of the same point was dampened with methyl ethyl ketone and removed employing unwoven fabric, whereby the thickness of the support material was determined, and the difference between these values was designated as the coated layer thickness. The streak generating number shows the result of having observed visually the sample over the overall length of the coating after coating and drying.

Evaluation Rankings for the Coating Layer Thickness Distribution in the Width Direction

A: Coating layer thickness distribution in the width direction was 0.1—less than 1.0 percent

B: Coating layer thickness distribution in the width direction was 1.0—less than 2.5 percent

C: Coating layer thickness distribution in the width direction was 2.5—less than 5.0 percent

D: Coating layer thickness distribution in the width direction was 5.0—9.9 percent

TABLE 2

| | Distribution of coat | | | | |
|---|---|---|---|---|---|
| | thickness in width | | | | |
| | direction | | Number of streaks | | |
| Die | | After | | After | |
| coater | Just after | service of | Just after | service of | |
| No. | production | one-year | production | one-year | Remarks |
| 1-1 | A | A | 0 | 0 | Embodiment |
| 1-2 | A | A | 1 | 0 | Embodiment |
| 1-3 | A | A | 1 | 2 | Embodiment |
| 1-4 | A | A | 3 | 4 | Embodiment |
| 1-5 | A | A | 4 | 5 | Embodiment |
| 1-6 | A | A | 51 | 109 | Comparative |
| | | | | | example |
| 1-7 | A | B | 0 | 0 | Embodiment |
| 1-8 | A | D | 0 | 0 | Comparative |
| | | | | | example |
| 1-9 | A | D | 0 | 0 | Comparative |
| | | | | | example |

Die coater No. 1-9 was made with bars which were baked on the baking table instead of being suspended after coated with a fluorine based resin. It was found that the straightness of the bars of this die coater was affected by the straightness of the baking table and the latent stresses of the bars from grinding gradually emerged to affect the distribution of the layer thickness after one year of service since the quantity of finish grinding of the bars and the stresses from this were great, even thought once the straightness of it was corrected into the original by finish grinding after a baking process.

Die coater No. 1-6 was constructed of bars which were not coated with a fluorine based resin. The layer samples made by this die coater had many streaks. Further, the portions of the die coater which were in contact with the coating solution became dirty with the coating solution and it was very time-consuming to clean the die coater. Therefore, this type of die coater is found to be not practical. Die coater No. 1-8 was constructed of bars which were baked in the suspension method of FIG. 6(c). It was found that this die coater had a bar deflection and the bar straightness was deteriorated, and the latent stresses of the bars from grinding gradually emerged to affect the distribution of the layer thickness after one year of service since the quantity of finish grinding of the bars and the stresses from this were great, even thought once the straightness of it was corrected into the original by finish grinding after a baking process.

When a bar coated with a fluorine based resin was baked while being hung with its one end face faced up, the straightness of the bar was acceptable because it was not affected by the condition of the baking table, which made it possible to produce bars with little distortion. Therefore, the straightness of the die coater which was constituted of these bars was improved to provide stable thickness distribution of coating layer in the width direction and favorable coating with little streak generation even after a long service time. Further, the die coater is clean and free from stains of the coating solution and cleaning of the die coater became easier. The effectiveness of this invention has been confirmed.

### Example 2

<Coating Solution for the Photosensitive Layer>

The coating solution for the photosensitive layer which was prepared by Example 1 was used.

<Coating Solution for the Surface Protection Layer>

The coating solution for the surface protection layer which was prepared by Example 1 was used.

<Preparation of a Die Coater>

Extrusion type die coaters of FIG. 2 was produced by the following method and assigned numbers of No. 2-1 to No. 2-8 to them. When producing the die coaters, stainless-steel (SUS630) bars having a longer side of 2000 mm long and a straightness of 1 μm were prepared, and coated respectively with a fluorine based resin while changing portions to be coated as shown in Table 3. Further, the coated bars were baked at 300° C. under bar-suspension conditions shown in Table 3, and each baked bar were finish-ground to have the original straightness before baking, and then the finish-ground bars were polished to have surface roughness of 0.1 μm as Ra and 0.5 μm as Rmax, and finally assembled into extrusion type die coaters.

The bars were burnt at 300° C. to clean the surfaces to be coated before coating the bars with a fluorine based resin. ETFE was used as the fluorine based resin and bars were coated with a layer of 300 μm thick.

Example 2 is the same as Example 1 in the grinding method and in the method of measurement of straightness, surface roughness Ra and Rmax, and thickness of a fluorine based resin. The portion to be coated with a fluorine based resin is indicated by a functional name of the bar on the die coater into which the bar is assembled. After finish grinding and polishing were completed, the completed bars were assembled into extrusion type die coaters No. 2-1 to 2-8 and starts to be used immediately and used for one year.

TABLE 3

| | | Portions coated with fluorine based resin | | | | |
|---|---|---|---|---|---|---|
| | | | | | External | |
| | Bar | | | | wall | |
| | suspension | Internal | Internal | | surface | |
| Die | method | wall of | wall of | Lip and | linked | |
| coater | for heat | slit | pocket | edge | with lip | |
| No. | treatment | section | section | sections | section | Remarks |
| 2-1 | F | Coated | Coated | Coated | Coated | Embodiment |
| 2-2 | F | Coated | Coated | Coated | Not | Embodiment |
| | | | | | coated | |
| 2-3 | F | Coated | Coated | Not | Not | Embodiment |
| | | | | coated | coated | |
| 2-4 | F | Coated | Not | Not | Not | Embodiment |
| | | | coated | coated | coated | |
| 2-5 | — | Not | Not | Not | Not | Comparative |
| | | coated | coated | coated | coated | example |
| 2-6 | G | Coated | Coated | Coated | Coated | Embodiment |
| 2-7 | H | Coated | Coated | Coated | Coated | Comparative |
| | | | | | | example |
| 2-8 | I | Coated | Coated | Coated | Coated | Comparative |
| | | | | | | example |

In Table 3, symbol F indicates suspension methods of FIG. 7(a), symbol G indicates suspension methods of FIG. 7(b), symbol H indicates suspension methods of FIG. 7(c), and symbol I indicates methods of placing a bar on a baking table as shown in FIG. 7(d). Bars of die coater No. 2-5 are not heat-treated because the bars are not coated with a fluorine based resin.

<Coating>

Employing each of die coaters 2-1 to 2-8 which had been just produced and each of die coaters 2-1 to 2-8 which had been used for one year, viscosity μ (Pa.s) of the light-sensitive layer coating solution prepared as above was adjusted to approximately 0.5 Pa.s, while viscosity μ (Pa.s) of the protective layer coating solution was adjusted to approximately 1.0 Pa.s. Subsequently, the resulting coating solutions were applied by coating with a coating width of 1,900 mm at a coating rate of 30 m/minute onto a support material which was prepared by connecting 10 belt-shaped support materials (made of PET) at a thickness of 175 μm, a width of 2,100 mm and each length of 1,000 m, so that a light-sensitive layer was arranged as a lower layer at a coated weight of 75 g/m² (wet weight), and the protective layer was arranged as an upper layer at a coated weight of 25 g/m² (wet weight), and resulting coating solution was dried, whereby samples were prepared. Viscosity was measured employing ROTOVISCO RV-12 of Haake, Inc. and viscosity at each shearing was measured. The pipes covered with a fluorine based resin (FEP) were employed in a coating solution supply path section.

<Evaluation>

Layer samples were provided by die coaters No. 2-1 to 2-8 immediately after the die coaters were produced and these after one-year service and the number of generated streaks and the distribution of layer thicknesses in the coating width direction of each layer sample were measured in the same manner as Example 1. Table 4 lists the results of measurement using the same evaluation ranking.

TABLE 4

| | Distribution of coat | | | | |
|---|---|---|---|---|---|
| | thickness in width | | Number of streaks | | |
| | direction | | | After | |
| Die | | After | | service | |
| coater | Just after | service of | Just after | of one- | |
| No. | production | one-year | production | year | Remarks |
| 2-1 | A | A | 0 | 0 | Embodiment |
| 2-2 | A | A | 1 | 2 | Embodiment |
| 2-3 | A | A | 2 | 3 | Embodiment |
| 2-4 | A | A | 3 | 5 | Embodiment |
| 2-5 | A | A | 47 | 99 | Comparative |
| | | | | | example |
| 2-6 | A | B | 0 | 0 | Embodiment |
| 2-7 | A | D | 0 | 0 | Comparative |
| | | | | | example |
| 2-8 | A | D | 0 | 0 | Comparative |
| | | | | | example |

It was found that the extrusion type die coaters of Example 2 had the same effects as the slide type die coaters of Example 1. The effectiveness of this invention has been confirmed.

### Example 3

<Coating Solution for the Photosensitive Layer>

The coating solution for the photosensitive layer which was prepared by Example 1 was used.

<Coating Solution for the Surface Protection Layer>

The coating solution for the surface protection layer which was prepared by Example 1 was used.

<Preparation of a Die Coater>

Slide type die coaters of FIG. 1 was produced by the following method and assigned numbers of No. 3-1 to No. 3-17 to them. When producing the die coaters, stainless-steel (SUS630) bars having a longer side of 2000 mm long was preheated as shown in Table 5 and a straightness of 1 μm was secured by grinding, and then the bars were coated with a fluorine based resin. Further, the coated bars were baked at a temperature shown in Table 5 under bar-suspension conditions shown in Table 5, and each baked bar were finish-ground to have a straightness of 1 μm was secured by finish grinding, and then the finish-ground bars were polished to have surface roughness of 0.1 μm as Ra and 0.5 μm as Rmax, and finally assembled into slide type die coaters.

The bars were burnt at the same temperature as the baking temperature to clean the surfaces to be coated before coating the bars with a fluorine based resin. Bars were coated with a layer of 100 μm thick of a PAI paint in which ETFE was dispersed. The same grinding method as Example 1 was used and the same measuring methods as Example 1 were used to measure the surface roughness and the fluorine based resin thickness.

Portions of bars forming a die coater, which were coated with a fluorine based resin were those which came in contact with a coating solution when they were assembled into a slide type die coater, such as pocket sections, coating solution supply ports, slit sections, edge sections, lip sections, slide surfaces and external wall surfaces connected to the lip sections. Immediately after finish grinding and polishing were completed, the completed bars were assembled into die coaters No. 3-1 to 3-17 and started to be used and used for three years.

TABLE 5

| | | | Bar suspension | |
|---|---|---|---|---|
| | Preheating | Baking | method for | |
| Die coater | temperature | temperature | heat | |
| No. | (° C.) | (° C.) | treatment | Remarks |
| 3-1 | 400 | 400 | A | Embodiment |
| 3-2 | 400 | 380 | A | Embodiment |
| 3-3 | 380 | 380 | A | Embodiment |
| 3-4 | 360 | 380 | A | Embodiment |
| 3-5 | 400 | 250 | A | Embodiment |
| 3-6 | 250 | 250 | A | Embodiment |
| 3-7 | 100 | 250 | A | Embodiment |
| 3-8 | 100 | 100 | A | Embodiment |
| 3-9 | 100 | 90 | A | Embodiment |
| 3-10 | 90 | 100 | A | Embodiment |
| 3-11 | 90 | 90 | A | Embodiment |
| 3-12 | 400 | 400 | C | Comparative |
| | | | | example |
| 3-13 | 360 | 380 | C | Comparative |
| | | | | example |
| 3-14 | 100 | 250 | C | Comparative |
| | | | | example |
| 3-15 | 100 | 90 | C | Comparative |
| | | | | example |
| 3-16 | 90 | 100 | C | Comparative |
| | | | | example |
| 3-17 | 90 | 90 | C | Comparative |
| | | | | example |

In Table 5, symbol A indicates suspension methods of FIG. 6(a) and symbol C indicates suspension methods of FIG. FIG. 6(c).

<Coating>

Layer samples were provided by die coaters No. 3-1 to 3-17 immediately after the production, these which were used for one year and these which were used for three years, while using the photosensitive layer coating solution and the protective layer coating solution which were prepared by Example 1 under the same coating and drying conditions as Example 1. Liquid viscosities were measured in the same method as Example 1. Pipes coated with a fluorine based resin (FEP) were used for coating solution supply paths.

<Evaluation>

Layer samples were provided by die coaters No. 3-1 to 3-17 immediately after the production, these which were used for one year and these which were used for three years, and the distribution of layer thicknesses was measured in the coating width direction of each layer sample in the same manner as Example 1. Table 6 lists the results of the measurement using the same evaluation ranking as Example 1.

TABLE 6

| | Distribution of coat thickness | | | |
|---|---|---|---|---|
| | in width direction | | | |
| Die | | After | After | |
| coater | Just after | service of | service of | |
| No. | production | one-year | three-years | Remarks |
| 3-1 | A | B | C | Embodiment |
| 3-2 | A | A | A | Embodiment |
| 3-3 | A | A | A | Embodiment |
| 3-4 | A | B | C | Embodiment |
| 3-5 | A | A | A | Embodiment |
| 3-6 | A | A | B | Embodiment |
| 3-7 | A | B | C | Embodiment |
| 3-8 | A | A | B | Embodiment |
| 3-9 | A | A | C | Embodiment |
| 3-10 | A | B | C | Embodiment |
| 3-11 | A | C | C | Embodiment |
| 3-12 | A | D | D | Comparative |
| | | | | example |
| 3-13 | A | C | D | Comparative |
| | | | | example |
| 3-14 | A | D | D | Comparative |
| | | | | example |
| 3-15 | A | D | D | Comparative |
| | | | | example |
| 3-16 | A | C | D | Comparative |
| | | | | example |
| 3-17 | A | D | D | Comparative |
| | | | | example |

Since die coater bars are preheated before being coated with a fluorine based resin, ground to eliminate distortions which has been made on the bars, coated with a fluorine based resin, and baked while each bar is hung with its one end face up, the bars are not affected by the surface condition of the baking table. Therefore, production of bars having less distortion has become possible. Further, it was found that the die coaters constituted of such bars had been improved in their straightness and could form layers of a constant thickness in the coating width direction steadily even after a long period service. Further, it has been found that the die coaters are almost free from stains due to the coating solutions and streak failures, and that the die coaters can be cleaned easily. The effectiveness of this invention has been confirmed.

There is provided a coating apparatus employing a die coater and a method of producing the die coater, wherein the die coater has a large width of 1 m or larger and is covered with a fluorine based resin for easy cleaning on a portion coming in contact with a coating solution, thereby making it possible to obtain coated products having a uniform coating layer thickness in the width direction of coating and having few coating failures. Accordingly because coating failures have decreased and layer thickness distribution has become stable, the product quality has become stable with an increase in the efficiency percentage.

What is claimed is:

1. A coating apparatus having a die coater incorporating at least two bars, the die coater comprising:
a pocket section for extending a coating solution in a coating width direction;
a coating solution supply port for supplying the coating solution to the pocket section; and
a slit section for discharging the coating solution from the pocket section to an object to be coated;
wherein at least a portion of a bar which forms a surface of the die coater and comes in contact with the coating solution is applied with coating of a fluorine based resin, and baking of the fluorine based resin is carried out in a baking furnace while the bar is suspended with one end face of the bar up, and then finish grinding is conducted for the bar.

2. The apparatus of claim 1,
wherein preheating is conducted for the bar at a temperature equal to or higher than a temperature of the baking for the fluorine based resin before the coating, and grinding is carried out after the preheating.

3. The apparatus of claim 2,
wherein the grinding includes a first grinding to remove distortion caused by the preheating and a second grinding to finish to final finishing form.

4. The apparatus of claim 1,
wherein the finish grinding includes a first finish grinding to remove distortion caused by the baking and a second finish grinding to remove thickness unevenness of the fluorine based resin caused by the coating.

5. The apparatus of claim 1,
wherein a temperature of the baking is 100 to 380° C.

6. The apparatus of claim 1,
wherein a straightness of a surface of the bar in the coating width direction, on which the coating has been carried out with the fluorine based resin is 0.1 to 10 μm.

7. The apparatus of claim 1,
wherein the bars have a surface roughness of a portion subjected to the coating within a range of 0.01 μm<Ra<1 μm and 0.1 μm<Rmax<5 μm.

8. The apparatus of claim 1,
wherein the bars are structure members of the die coater such that a gap of the slit section formed by at least two bars is narrower at an outlet than an inlet of a coating solution and a gap D at the outlet is D≦5×10⁻⁵ [m], and the die coater jets the coating solution in a layer form in order to make the coating solution collide with the object to be coated with a predetermined gap for coating, the object being disposed or conveyed with no contact with the outlet of the slit section.

9. The apparatus of claim 1,
wherein the bars are structure members of an extrusion type die coater that extrudes the coating solution from the slit section formed by at least two bars, and forms a bead of the coating solution for coating between a vicinity of a coating solution extruding portion of the slit section and the object to be coated.

10. The apparatus of claim 1,
wherein the bars are structure members of a slide type die coater that extrudes the coating solution from the slit section formed by at least two bars, allows the coating solution having been extruded to flow down along a slope which is continuous with the outlet of the slit section, then forms a bead of the coating solution between the object to be coated and a vicinity of an end portion of the slope, and coats the coating solution.

11. The apparatus of claim 1,
wherein the bars are structure members of a curtain type die coater that allows the coating solution having been extruded from the slit section formed by at least two bars to fall freely for coating onto the object to be coated.

12. The apparatus of claim 1,
wherein the bars are structure members of a die coater having a coating width of 1 meter or larger.

13. The apparatus of claim 1,
wherein a surface of the object opposite to a coated surface thereof is supported by a back roller.

14. The apparatus of claim 1,
wherein the object is supported by a support roller at a position near the die coater.

15. The apparatus of claim 1,
wherein the coating solution is a coating solution for a photosensitive layer containing a silver component for a heat-developing photosensitive material or a coating solution for a non-photosensitive protective layer.

16. A method of producing a die coater structured of at least two bars having a pocket section to extend a coating solution in a coating width direction, a coating solution supply port to supply a coating solution to the pocket section, and a slit section to discharge a coating solution from the pocket section to an object to be coated, wherein at least a portion of a surface of the die coater coming in contact with the coating solution is coated with a fluorine based resin, the method comprising:
a coating process of coating at least a portion of a surface of the die coater coming in contact with the coating solution with the fluorine based resin;
a baking process of the fluorine based resin conducted in a baking furnace while a bar is suspended with one end face of the bar up; and
a finish grinding process conducted after the baking process; and
a mounting process of the bar to produce the die coater.

17. The method of claim 16,
wherein a preheating process is conducted and then a grinding process is conducted before the coating process.

18. The method of claim 17,
wherein a preheating process is conducted for the bar at a temperature equal to or higher than a temperature of the baking for the fluorine based resin.

19. The method of claim 17,
wherein the grinding process includes a first grinding process to remove distortion caused in the preheating process and a second grinding process to finish to final finishing form.

20. The method of claim 16,
wherein a temperature of the baking process is 100 to 380° C.

21. The method of claim 16,
wherein the finish grinding process includes a first finish grinding process to remove distortion caused in the baking process and a second finish grinding process to remove thickness unevenness of the fluorine based resin caused in the coating process.

22. The method of claim 16,
wherein the finish grinding is conducted such that the straightness of the surface of the bar in the coating width direction on which the coating process has been carried out with the fluorine based resin is 0.1 to 10 μm and a surface roughness of a portion subjected to the coating process is within a range of 0.01 μm<Ra<1 μm and 0.1 μm<Rmax<5 μm.
